(19) United States
(12) Patent Application Publication
(10) Pub. No.: US 2025/0033319 A1
(43) Pub. Date: Jan. 30, 2025

(54) MICROSTRUCTURED SURFACE AND ARTICLES WITH LOWER VISIBILITY OF SCRATCHES AND METHODS

(71) Applicant: 3M INNOVATIVE PROPERTIES COMPANY, St. Paul, MN (US)

(72) Inventors: Vivian W. Jones, Woodbury, MN (US); Gordon A. Kuhnley, St. Paul, MN (US); Joseph D. Wheeldon, Boyceville, WI (US); Qunyi Chen, Woodbury, MN (US); Jodi L. Connell, St. Paul, MN (US); Alexander C. Eldredge, Mahtomedi, MN (US); Lijun Zu, Woodbury, MN (US); Lynn E. Lorimor, Minneapolis, MN (US); Feng Bai, Woodbury, MN (US); Olester Benson, Woodbury, MN (US)

(21) Appl. No.: 18/714,236

(22) PCT Filed: Dec. 2, 2022
(86) PCT No.: PCT/IB2022/061717

§ 371 Date: May 29, 2024

Related U.S. Application Data
(60) Provisional application No. 63/286,648, filed on Dec. 7, 2021.
(60) Provisional application No. 63/351,926, filed on Jun. 14, 2022.
(60) Provisional application No. 63/402,623, filed on Aug. 31, 2022.

(51) Int. Cl. B32B 3/30; B32B 27/08; B32B 27/30

(52) U.S. Cl. CPC B32B 3/30; B32B 27/08; B32B 27/304; B32B 2307/406; B32B 2307/41; B32B 2307/412; B32B 2307/7375; B32B 2405/00; B32B 2553/00

(57) ABSTRACT

Structured surfaces are described. In one embodiment, the structured surface comprises a plurality of structures having complement cumulative slope magnitude distribution (Fcc) such that at least 30, 40, 50, 60, 70, 80 or 90% of structures have a slope greater than 10 degrees; and less than 80% of the structures have a slope greater than 35 degrees. In other embodiments, the structures comprise peaks and valleys defined by a Cartesian coordinate system such that the peaks and valleys have a width and length in the x-y plane and a height in the z-direction and at least a portion of the peaks and/or valleys vary in height in the y direction and/or the x-direction by at least 10% of the average height. Articles and methods are also described.

### BACKGROUND

US2017/0100332 (abstract) describes an article that include a first plurality of spaced features. The spaced features are arranged in a plurality of groupings; the groupings of features include repeat units; the spaced features within a grouping are spaced apart at an average distance of about 1 nanometer to about 500 micrometers; each feature having a surface that is substantially parallel to a surface on a neighboring feature; each feature being separated from its neighboring feature; the groupings of features being arranged with respect to one another so as to define a tortuous pathway. The plurality of spaced features provide the article with an engineered roughness index of about 5 to about 20.

WO2013/003373 and WO 2012/058605 describe surfaces for resisting and reducing biofilm formation, particularly on medical articles. The surfaces include a plurality of microstructure features.

As described in WO 2021/033151, although articles with specific microstructure features are useful for reducing the initial formation of a biofilm, particularly for medical articles; in the case of other articles, such microstructured surfaces can be difficult to clean. This is surmised to be due at least in part to the bristles of a brush or fibers of a (e.g. nonwoven) wipe being larger than the space between microstructures. Surprisingly, it has been found that some types of microstuctured surfaces exhibit better microorganism (e.g. bacteria) removal when cleaned, even in comparison to smooth surfaces. Such microstructured surfaces have also been found to provide a reduction in microbial touch transfer.

### SUMMARY

Microstructured surfaces as described in WO 2021/033151 may be damaged during use. For example, the microstructured surface may be scratched. Depending on the shape and dimension of such scratches, scratches may or may not substantially impair the cleanability or touch transfer properties. For example if one a small portion of the microstructured surface is damaged, the microstructured surface may substantially retain its cleanability and touch transfer properties. However, the visibility of damage, such as scratching, can be aesthetically less appealing. Thus, industry would find advantage in microstructured surfaces that address this problem.

In one embodiment, a structured surface is described comprising a plurality of structures having a complement cumulative slope magnitude distribution (Fcc) such that at least 30, 40, 50, 60, 70, 80 or 90% of structures have a slope greater than 10 degrees; and less than 80% of the structures have a slope greater than 35 degrees.

In some embodiments, the structures comprise peaks and valleys defined by a Cartesian coordinate system such that the peaks and valleys have a width and length in the x-y plane and a height in the z-direction and at least a portion of the peaks and/or valleys vary in height in the y direction by at least 10% of the average height.

In some embodiments, the structures comprise peaks and valleys defined by a Cartesian coordinate system such that the peaks valleys have a width and length in the x-y plane and a height in the z-direction and at least a portion of the peaks and/or valleys vary in height in the x direction by at least 10% of the average height.

In some embodiments, the structures comprise facets that form continuous or semi-continuous surfaces in the same direction.

In some embodiments, the structured surface comprises less than 50, 40, 30, 20 or 10% of flat surface area that is parallel to the planar base layer.

In some embodiments, the structured surface comprises valleys that lack intersecting walls.

In some embodiments, the structured surface comprises valleys having an average width ranging from 1 micron to 1 mm.

In some embodiments, the structured surface is disposed on a planar base layer. The structured surface and planar base layer may comprise an organic polymeric material.

In some embodiments, the structured surface alone or in combination with the planar base layer has one or more properties selected from:
less visually apparent scratches than a linear prism film;
a transmission of at least 90 or 95%;
a clarity of less than 10, 5, or 1;
a gloss at 20 degrees of less than 10 or 5;
a gloss at 85 degrees of less than 10 or 5;
a luminance at 0 degrees of at least 12 candela/square meter (cd/m²)+/−1 for a polar angle ranging from −40 to +40 degrees; and a luminance at 90 degrees of at least 12 cd/m²+/−1 for a polar angle ranging from −40 to +40 degrees.

In another embodiment, a structured surface is described comprising a plurality of structures having a complement cumulative slope magnitude distribution (Fcc) such that at least 30, 40, 50, 60, 70, 80 or 90% of the structures have a slope greater than 10 degrees; and one or more of the following criteria
i) at least 10, 20, or 30% of structures have a slope greater than 50 degrees;
ii) at least 10 or 20% of structures have a slope greater than 60 degrees;
iii) less than 70, 60, or 50% of structures have a slope greater than 40 degrees;
iv) less than 90 or 80% of structures have a slope greater than 30 degrees; and
v) less than 90% of structures have a slope greater than 20 degrees.

In another embodiment, a structured surface is described comprising a plurality of structures having a complement cumulative slope magnitude distribution (Xcc) such that at least 45, 50, or 60% of the structures have a slope greater than 30 or 35 degrees; and less than 85 or 80% of the structures have a slope greater than 40 degrees.

In another embodiment, a structured surface is described comprising a plurality of structures having a complement cumulative slope magnitude distribution (Ycc) such that at least 20, 25, 30, 35, 40, 45, or 50% of the structures have a slope greater than 10 degrees; and less than 55, 50, 45, 40, 35, 30, 25 or 20% of the structures have a slope greater than 30 degrees.

In another embodiment, a method of making a structured surface is described comprising providing a tool comprising a structured surface of the previous claims and utilizing the tool to impart the structured surface on a film or article. In some embodiments, utilizing the tool comprises embossing a surface with the tool, casting and curing a polymerizable resin onto the tool, or thermal extrusion of a polymer onto the structured surface of the tool.

In other embodiments, article are described comprising a structured surface as described herein. In some embodiments, the article is a film or tape further comprising a (e.g. permanent or removable) adhesive on the opposing surface of the planar base layer. In some embodiments, the structured surface is subject to being touched, or coming in contact with people and/or animals, or cleaned during normal use, or a combination thereof. In some embodiments, the structured surface can provide a reduction in microorganism touch transfer of at least 25, 30, 35, 40, 45, 50, 60, 70, 80, 90, 95, or 99%. In some embodiments, the structured surface can provide a log 10 reduction of microorganism (e.g. bacteria) of at least 2, 3, 4, 5, 6, 7 or 8 after cleaning.

In another embodiment, an article is described comprising a microstructured surface comprising an array of peak structures and adjacent valleys wherein the valleys have a maximum width ranging from 1 microns to 1000 microns wherein the peaks are defined by a Cartesian coordinate system such that the peaks have a width and length in the x-y plane and a height in the z-direction and at least a portion of the peaks vary in height or slope in the y direction. In a favored embodiment, the article is suitable for providing a reduction in microorganism touch transfer and/or a log 10 reduction of microorganism (e.g. bacteria) after cleaning as previously described.

In another embodiment, a method of providing an article having a surface with reduced touch transfer and/or increased microorganism removal when cleaned is described comprising providing a microstructured surface, as described herein, on an article. In one embodiment, the microstructured surface is provided by adhering a film comprising the microstructured surface onto a surface of the article.

### BRIEF DESCRIPTION OF THE DRAWINGS

FIG. 1 is a perspective review of a Cartesian coordinate system of a surface that can be utilized to describe various microstructured surfaces;

FIG. 2 is a cross-sectional view of a microstructured surface;

FIG. 2A is a perspective view of a microstructured surface;

FIG. 3 is a perspective view of a microstructured surface comprising a linear array of prisms;

FIGS. 4A-4B are three-dimensional topographical maps of microstructured surfaces comprising an array or peak structures;

FIGS. 5A-5C are three-dimensional topographical maps of microstructured surfaces comprising an array or peak structures;

FIG. 6 is a cross-sectional view of peak structures with various apex angles;

FIG. 7 is a cross-sectional view of peak structures with a rounded apexes;

FIG. 8 is a plot of the complement of the cumulative gradient (i.e. slope) magnitude distribution (Fcc);

FIG. 9 is a plot of the complement of the cumulative X slope (Ycc);

FIG. 10 is a plot of the complement of the cumulative Y slope (Xcc);

FIG. 11 is a schematic side view of a cutting tool system;

FIG. 12A-12D are schematic side views of various cutters;

FIGS. 13A and 13B are plots of luminance as a function of polar viewing angle; and

FIG. 14 is a schematic side view of a structure.

### DETAILED DESCRIPTION

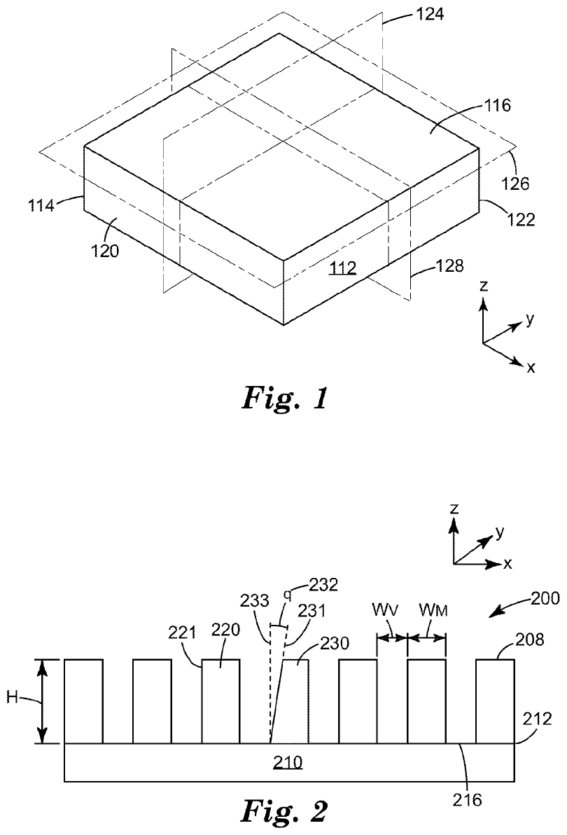

With reference to FIG. 1, a microstructured surface can be characterized in three-dimensional space by superimposing a Cartesian coordinate system onto its structure. A first reference plane 124 is centered between major surfaces 112 and 114. First reference plane 124, referred to as the y-z plane, has the x-axis as its normal vector. A second reference plane 126, referred to as the x-y plane, extends substantially coplanar with surface 116 and has the z-axis as its normal vector. A third reference plane 128, referred to as the x-z plane, is centered between first end surface 120 and second end surface 122 and has the y-axis as its normal vector.

In some embodiments, the articles are three-dimensional on a macroscale. However, on a microscale (e.g. surface area that includes at least two adjacent microstructures with a valley or channel disposed between the microstructures) the base layer/base member can be considered planar with respect to the microstructures. The width and length of the microstructures are in the x-y plane and the height of the microstructures is in the z-direction. Further, the base layer is parallel to the x-y plane and orthogonal to the z-plane.

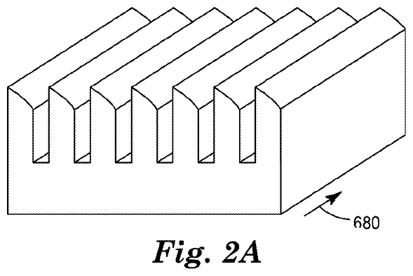

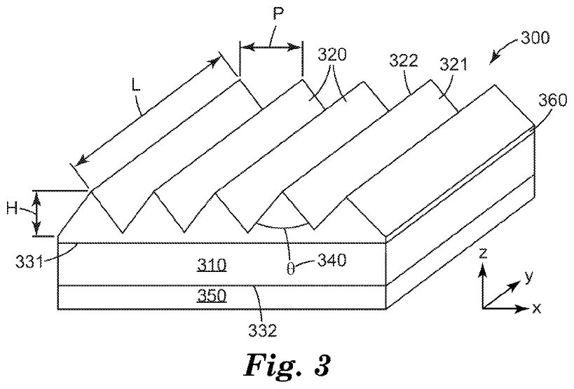

FIG. 2 is an illustrative cross-section of a microstructured surface 200. Such cross-section is representative of a plurality of discrete (e.g. post or rib) microstructures 220. The microstructures comprise a base 212 adjacent to an (e.g. engineered) planar surface 216 (surface 116 of FIG. 1 that is parallel to reference plane 126). Top (e.g. planar) surfaces 208 (parallel to surface 216 and reference plane 26 of FIG. 1) are spaced from the base 212 by the height (“H”) of the microstructure. The side wall 221 of microstructure 220 is perpendicular to planar surface 216. When the side wall 221 is perpendicular to planar surface 216, the microstructure has a side wall angle of zero degrees. In the case of perpendicular side walls, of a peak microstructure are parallel to each other and parallel to adjacent microstructures having perpendicular side walls. Alternatively, microstructure 230 has side wall 231 that is angled rather than perpendicular relative to planar surface 216. The side wall angle 232 can be defined by the intersection of the side wall 231 and a reference plane 233 perpendicular to planar surface 216 (perpendicular to reference plane 126 and parallel to reference plane 128 of FIG. 1). In the case of privacy films, such as described in U.S. Pat. No. 9,335,449; the wall angle is typically less than 10, 9, 8, 7, 6, or 5 degrees. Since the channels of privacy film comprise light absorbing material, larger wall angle can decrease transmission. However, as described in WO 2021/033151, wall angles approaching zero degrees are also more difficult to clean.

WO 2021/033151 describes microstructured surfaces comprising microstructures having sufficiently high side wall angles that are amenable to microorganism removal. The microstructured surfaces comprise microstructures having side wall angles greater than 1, 2, 3, 4, 5, 6, 7, 8, 9, or 10 degrees. In some embodiments, the side wall angle is at least 11, 12, 13, 14, 15, 16, 17, 18, 19, or 20 degrees. In other embodiments, the side wall angle is at least 21, 22, 23, 24, 25, 26, 27, 28, 29, or 30 degrees. For example, in some embodiments, the microstructures are cube corner peak structures having a side wall angle of 30 degrees. In other embodiments, the side wall angle is at least 31, 32, 33, 34, 35, 36, 37, 38, 39, 40, 41, 42, 43, 44, or 45 degrees. For example, in some embodiments, the microstructures are prism structures having a side wall angle of 45 degrees. In other embodiments, the side wall angle is at least 46, 47, 48, 49, 50, 51, 52, 53, 54, 55, 56, 57, 58, 59, or 60 degrees. It is appreciated that the microstructured surface would be beneficial even when some of the side walls have lower side wall angles. For example, if half of the array of peak structures have side wall angles within the desired range, about half the benefit of improved microorganism (e.g. bacteria) removal may be obtained. Thus, in some embodiments, less than 50, 45, 40, 35, 30, 25, 20, 15, 10, 5 or 1% of the peak structures have side wall angles less than 10, 9, 8, 7, 6, 5, 4, 3, 2, or 1 degree. In some embodiments, less than 50, 45, 40, 35, 30, 25, 20, 15, 10, 5 or 1% of the peak structures have side wall angles less than 30, 25, 20, or 15 degrees. In some embodiments, less than 50, 45, 40, 35, 30, 25, 20, 15, 10, 5 or 1% of the peak structures have side wall angles less than 40, 35, or 30 degrees. Alternatively at least 50, 60, 70, 80, 90, 95 or 99% of the peak structures have a sufficiently large side wall angle, as described above.

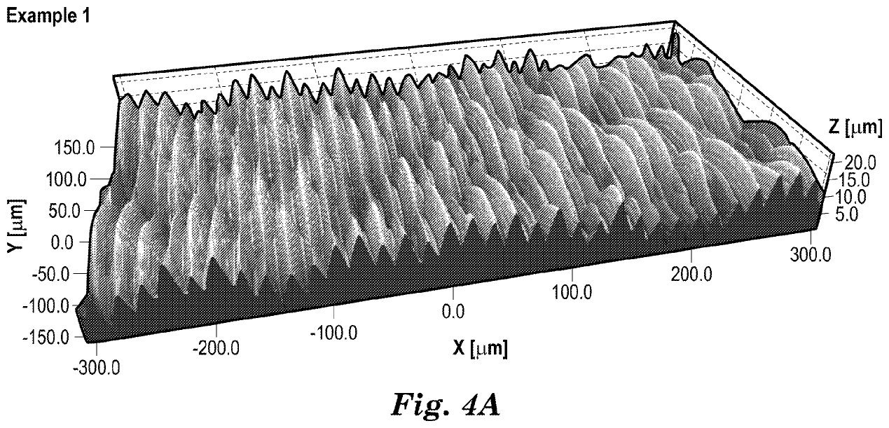

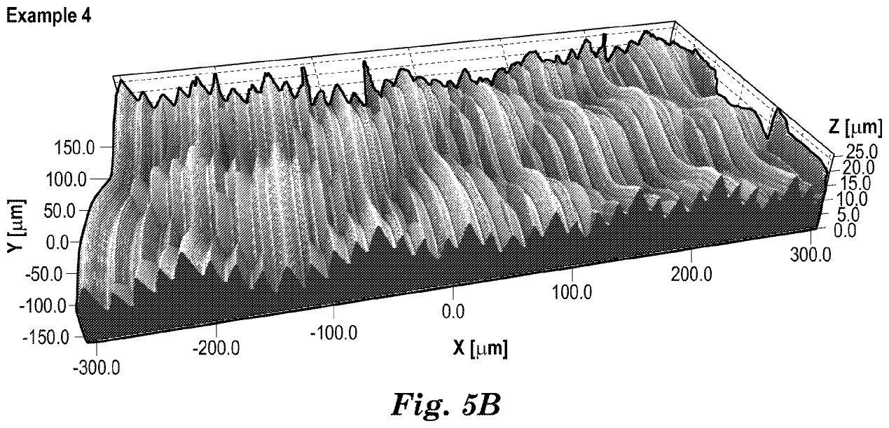

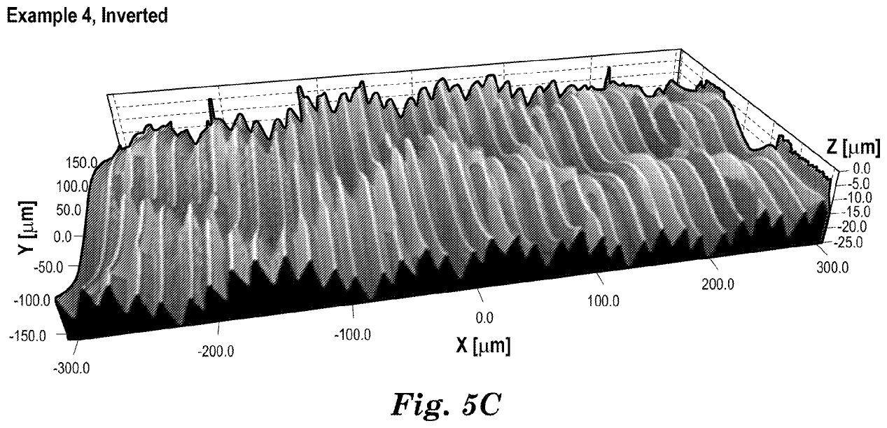

As described in WO 2021/033151, one embodied microstructured surface having suitable side angles has the same surface as a brightness enhancing film. With reference to FIG. 3, such microstructured surface 300 comprises a linear array of regular right prisms 320. Each prism has a first facet 321 and a second facet 322. The prisms are typically formed on a (e.g. preformed polymeric film) base member 310 that has a first planar surface 331 (parallel to reference plane 126) on which the prisms are formed and a second surface 332 that is substantially flat or planar and opposite first surface. By right prisms it is meant that the apex angle θ, 340, is typically about 90°. However, this angle can range from 700 to 1200 and may range from 800 to 100°. In some embodiments, the apex angle can be greater than 60, 65, 70, 75, 80, or 85°. In some embodiments, the apex angle can be less than 150, 145, 140, 135, 130, 125, 120, 110, or 100°. These apexes can be sharp (as shown), rounded (as shown in FIG. 7) or truncated. In some embodiments, the included angle of the valley is in the same range as the apex angle. The spacing between (e.g. prism) peaks may be characterized as pitch (“P”). In this embodiment, the pitch is also equal to the maximum width of the valley. Thus, the pitch is greater than 1, 2, 3, 4, 5, 6, 7, 8, 9, or 10 microns ranging up to 250 microns, as previously described. The length (“L”) of the (e.g. prim) microstructures is typically the largest dimension and can span the entire dimension of the microstructured surface, film or article. The prism facets need not be identical and the prisms may be tilted with respect to each other, as shown in FIG. 6.

The microstructured surfaces, such as depicted in FIG. 3, may be described as having a regular repeating pattern of microstructures.

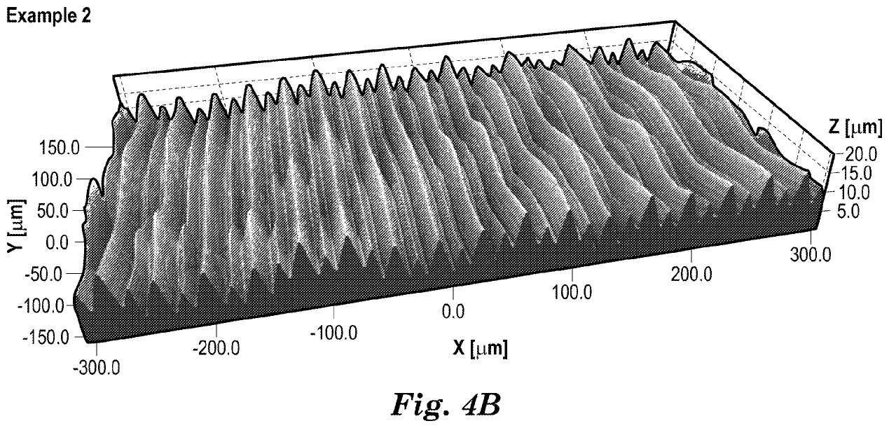

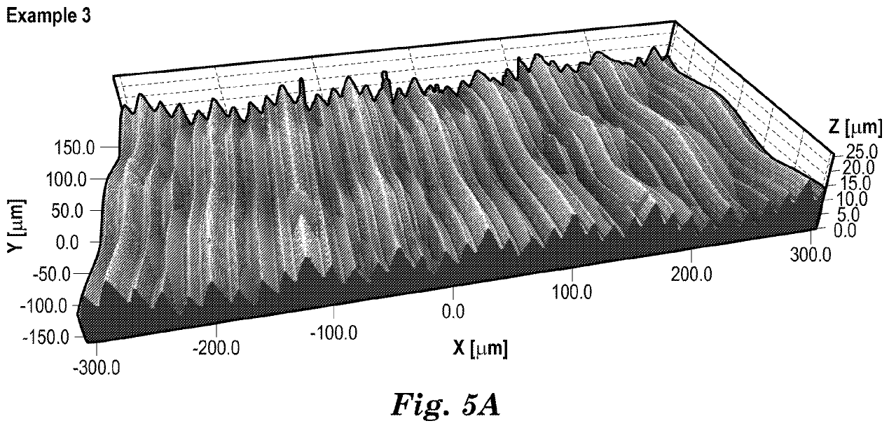

Presently described are more complex microstructured surfaces, such as illustrated by FIGS. 4A-4B and 5A-5C. The microstructured surfaces can be made using any suitable fabrication technique. For example, the microstructures can be fabricated using microreplication from a tool. The tool may be fabricated using any suitable fabrication method, such as by using engraving or diamond turning. Exemplary methods are known in the art, such as described in U.S. Pat. No. 8,888,333; WO2000/048037; U.S. Pat. Nos. 7,140,812; 7,350,442 and 7,328,638 (Gardiner); incorporated herein by reference.

FIG. 7 is a schematic side-view of a cutting tool system 1000 that can be used to cut a tool which can be used to produce films with microstructured surfaces of the disclosure. Cutting tool system 1000 employs a thread cut lathe turning process and includes a roll 1010 that can rotate around and/or move along a central axis 1020 by a driver 1030, and a cutter 1040 for cutting the roll material. The cutter is mounted on a servo 1050 and can be moved into and/or along the roll along the x-direction by a driver 1060. In general, cutter 1040 can be mounted normal to the roll and central axis 1020 and be driven into the engravable material of roll 1010 while the roll is rotating around the central axis. The cutter can be then driven parallel to the central axis to produce a thread cut. Cutter 1040 can be simultaneously actuated at high frequencies and low displacements to produce features in the roll that when microreplicated result in microstructured surfaces of the disclosure.

Servo 1050 can be a fast tool servo (FTS) and can include a solid state piezoelectric (PZT) device, often referred to as a PZT stack, which rapidly adjusts the position of cutter 1040. FTS 1050 allows for highly precise and high speed movement of cutter 1040 in the x-, y- and/or z-directions, or in an off-axis direction. Servo 1050 can be any high quality displacement servo capable of producing controlled movement with respect to a rest position. In some embodiments, servo 1050 can reliably and repeatably provide displacements in a range from 0 to about 20 microns with at least about 0.1 micron resolution. However, it is appreciated that larger cutting tool systems can be made to accommodate larger displacements and therefore structures of greater heights. It is also appreciated that cutting tool systems with better resolution can be used for smaller structures (e.g. 1 micron).

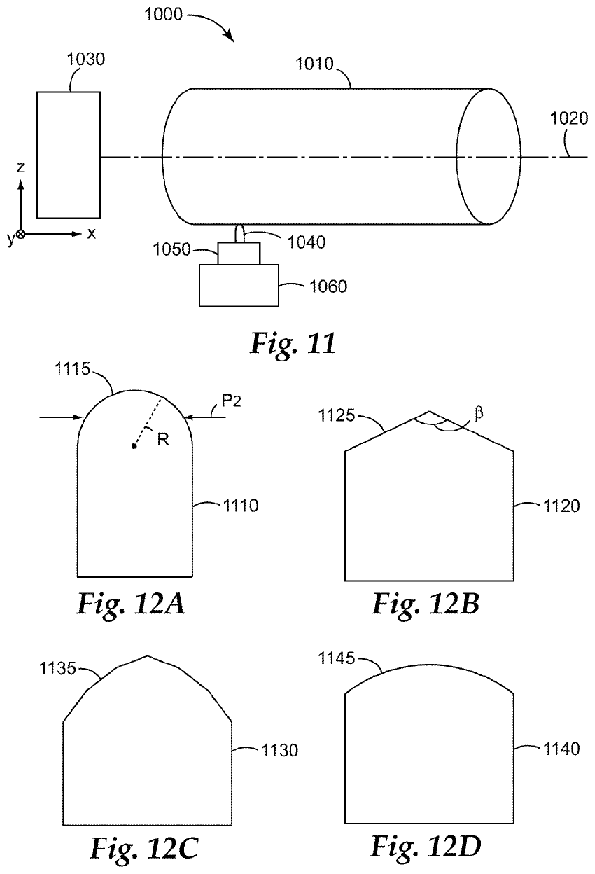

Driver 1060 can move cutter 1040 along the x-direction parallel to central axis 1020. In some cases, the displacement resolution of driver 1060 is at least about 0.1 microns, or at least about 0.01 microns. Rotary movements produced by driver 1030 are synchronized with translational movements produced by driver 1060 to accurately control the resulting shapes of microstructures 160. The engravable material of roll 1010 can be any material that is capable of being engraved by cutter 1040. Exemplary roll materials include metals such as copper, various polymers, and various glass materials. To prepare the tools for creating the exemplary microstructured film surfaces of FIGS. 4A-5D, cutter 1040 was shaped like cutter 1120 (FIG. 12B) having a rounded tip with radius that ranged between 1 and 3 microns and an apex angle beta of 80 degrees (±5 degrees). The surface of the tool typically has a surface roughness of less than 50, 40, 30, or 20 nm. Thus, the surface of the microstructures can have this same surface roughness. It is appreciated that the surface roughness of the tool/surface of the microstructures does not include the roughness contributed by the microstructures and thus is not the same as the roughness of the microstructured surface.

Referring back to FIG. 7, the rotation of roll 1010 along central axis 1020 and the movement of cutter 1040 along the x-direction while cutting the roll material defines a thread path around the roll that has a pitch P along the central axis. As the cutter moves along a direction normal to the roll surface to cut the roll material, the width of the material cut by the cutter changes as the cutter moves or plunges in and out. The cutter 1040 is angularly adjusted and vertically displaced in such a fashion to create a thread path that may have some element of over-cutting that eliminates portions of the previously created undulating, pseudo-random pattern(s). This process of angular adjustment and vertical displacement is repeated 3-7 times, or however many are needed, to engrave the entire surface of the roll 1010 with a pattern. Additional details concerning preparing the microstructured tool surfaces can be found in the forthcoming examples. The engraved roll 1010 serves as the tool for preparing films with microstructured surfaces that are a negative replication of the microstructured surface of the tool.

Although this cutting method is described with respect to rotation of a roll, randomizing the displacement in the y-direction and/or randomizing the displacement in the x-direction can also be utilized to cut a planar surface. Likewise, overcutting can also be utilized to cut a planar surface.

It is also appreciated that some of the thread paths formed by the cutting tool may not incorporate randomized displacement or overcutting. For example, portions of the array of FIGS. 4A-5D may comprise a regular repeating pattern such as the linear array of prisms as shown in FIG. 3.

In some embodiments, a single cutter is used for cutting the array of microstructures. In other embodiments, more than one cutter is used for cutting the array of microstructures. For example, taller peaks may be formed with a cutter having a rounded tip and shorter peaks may be formed with a cutter having sharp or less rounded tips.

Further, although this cutting method is exemplified with respect to modifying the fabrication of an array of linear prisms, these same principles of randomizing the displacement in the y-direction alone and/or randomizing the displacement in the x-direction and/or overcutting can also be utilized to modify the fabrication of other microstructured arrays such as cube corner elements including preferred geometry cube corner elements; both of which are described in WO 2021/033151, incorporated herein by reference. In this embodiment, the microstructured surface may be characterized as comprising modified cube corner structures or modified preferred geometry cube corner structures.

FIGS. 4A-4B and 5A-5C are perspective views of illustrative (e.g. micro) structured surfaces comprising an array of peak structures according to the present invention. Notably, these surfaces have both similarities and differences in comparison to FIG. 3.

Notably, the cross-sectional view of the peak structures of both the linear prisms of FIG. 3 and FIGS. 4A-4B and 5A-5C have a triangular cross section. In some embodiments, the surfaces of FIGS. 4A-4B and 5A-5C may be characterized as “modified” linear prisms. The peak structures of both the linear prisms of FIG. 3 and FIGS. 4A-4B and 5A-5C comprise facets, or in other words faces, that form continuous surfaces in the same direction. When the microstructured surface comprises an array of modified cube corner structures the peak structures comprise facets that form semi-continuous surfaces in the same direction, as described in WO 2021/033151. When the microstructured surface comprises an array of modified preferred geometry cube corner structures the peak structures comprise facets that form both continuous and semi-continuous surfaces in the same direction, as described in WO 2021/033151.

When a microstructured surface comprises a regular repeating pattern, such as shown by FIG. 3, various dimensions such has peak height and maximum valley width can be determined by a cross-section orthogonal to the y-axis. Various angles such as the apex angle and side wall angle can also be determined by a cross-section orthogonal to the y-axis. However, when the microstructured surface is not a regular repeating pattern, or in other words is a more complex microstructured surface, multiple cross sections may be utilized to determine these parameters. Further, when the microstructure surface comprises peaks and valleys with different peak heights, different valley depths, different angles, etc. these parameters may more commonly be expressed for example by a minimum, maximum, or average value. The (micro)structures surfaces, as illustrated by FIGS. 4A-4B and 5A-5C can be characterized as having greater variability or in other words greater randomness as compared to the linear prisms of FIG. 3.

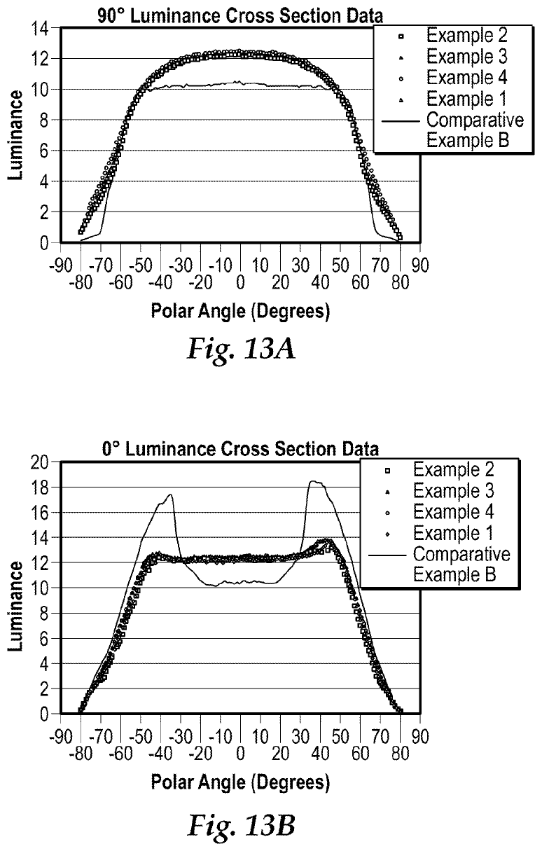

In some embodiments, the greater randomness contributes to the optical properties. For example, FIGS. 13A and 13B are plots of luminance as a function of polar viewing angle. Notably, the (micro)structured films of Examples 1-4, illustrated by FIGS. 4A-4B and 5A-5B have a luminance at 90 degrees of greater than 10, 11 or 12 cd/m² for a viewing angle or angles ranging from −40 to +40 degrees. Examples 1-4 also have a luminance of greater than 10, 11 or 12 cd/m² at 0 degrees for a viewing angle or angles ranging from −40 to +40 degrees. Notably, the prism film of Comparative Example B, illustrated by FIG. 3, has a lower luminance at 90 degrees. Further, Comparative Example B has a lower luminance at 0 degrees for viewing angles ranging from about −30 to +30 degrees and a significantly higher luminance for viewing angles ranging from about −30 to −60 and +30 to +60. The luminance at 0 degrees for the described (micro)structured films (e.g. of Examples 1-4) varies by less than 5, 4, 3, 2, or 1 cd/m² for viewing angles ranging from −40 to +40 degrees. Hence, the described (micro)structures surfaces have a more uniform luminance as compared to the prism film of Comparative Example B. In some embodiments, the described (micro)structured surfaces, illustrated by FIGS. 4A-4B and 5A-5B, exhibit less visually apparent scratches than a linear prism film of FIG. 3, as described in greater detail in the forthcoming examples.

The depicted linear prisms of FIG. 3 comprise valleys having nominally the same depth. Further, the depicted linear prisms of FIG. 3 comprise valleys having nominally the same width. In contrast, the (e.g. modified linear prism) microstructured surface of FIGS. 4A-4B and 5A-5C comprises peaks and/or valleys of different heights. Further, the (e.g. modified linear prism) microstructured surfaces of FIGS. 4A-4B and 5A-5C comprise peaks and/or valleys of different widths. The minimum and maximum valley height, valley width, peak height and peak width of the microstructured surfaces of FIGS. 4A-4B and 5A-5B are reported in the following tables.

Valley Dimensions

| | Minimum | Maximum | Minimum | Maximum |
|---|---|---|---|---|
| | Valley | Valley | Valley | Valley |
| Example | Height | Height | Width | Width |
| Example 1 | 3.75 | 8.16 | 9.08 | 17.33 |
| Example 2 | 7.40 | 12.40 | 11.50 | 16.50 |
| Example 3 | 3.65 | 8.27 | 7.45 | 17.40 |
| Example 4 | 6.86 | 10.73 | 11.56 | 18.15 |

Notably the valley structures vary in height (difference between the minimum and maximum) by at least 1, 2, 3, 4 or 5 microns. In some embodiments, the valley structures vary in height by no greater than 20, 10, 15, or 5 microns. Notably the valley structures vary in width (difference between the minimum and maximum) by at least 1, 2, 3, 4, 5, 6, 7, 8, 9, or 10 microns. In some embodiments, the valley structures vary in height by no greater than 20, 10, 15, or 5 microns

Peak Dimensions

| | Minimum | Maximum | Average | Minimum | Maximum |
|---|---|---|---|---|---|
| | Peak | Peak | Peak | Peak | Peak |
| Example | Height | Height | Height | Width | Width |
| Example 1 | 11.3 | 15.0 | 11.7 | 9.1 | 19 |
| Example 2 | 10.7 | 11.2 | 9.8 | 9.9 | 18.2 |
| Example 3 | 10.8 | 15.6 | 10.9 | 10.8 | 16.5 |
| Example 4 | 15.1 | 19.7 | 13.3 | 10.1 | 17.8 |

Notably the peak structures vary in height (difference between the minimum and maximum) by at least 1, 2, 3, 4 or 5 microns. In some embodiments, the peak structures vary in height by no greater than 20, 10, 15, or 5 microns. Notably the peak structures vary in width (difference between the minimum and maximum) by at least 1, 2, 3, 4, 5, 6, 7, 8, 9, or 10 microns. In some embodiments, the peak structures vary in height by no greater than 20, 10, 15, or 5 microns.

It is appreciated that the amount of variation can be a function of the size. Stated otherwise, the amount of variation is typically at least 10, 15, 20, 25, 30, 35, 40, 45, or 50% of the average dimension (e.g. peak height, peak width, valley height, valley width, etc.) In some embodiments, the amount of variation is less than 45, 40, 35, 30, 25, 20, 15%. Thus, when the microstructures surface has an average dimension of 10 microns, the amount of variation typically ranges from 1 to 5 microns. Likewise, when the microstructures surface has an average dimension of 1 microns, the amount of variation typically ranges from 0.1 to 0.5 microns.

FIG. 5C is a negative replication or in other words inverse of the surface of FIG. 5B. A negative replication can be made, for example, by casting and cure a polymerizable resin onto a metal tool. Upon removing the cured polymerizable resin from the metal tool, the resulting film will have a microreplicated surface wherein the peak structures of the tool correspond to valleys, or in other words cavities, in the film and the valleys of the tool correspond to peak structures in the films. For this embodiment, the peak dimensions of the structured surface of FIG. 5C are the same as the valley dimensions described for Example 4 of FIG. 5B. Further, the valley dimensions of the structured surface of FIG. 5C are the same as the peak dimensions of Example 4, depicted by FIG. 5B.

The complex surfaces of the present invention were characterized using surface analysis. Topographic data was collected using a VK-200 Keyence Laser Scanning Confocal Microscope (Keyence Corporation, Itasca, IL). A stitched image was generated using the native image assembly software provided with the microscope. An array of 35 individual images (using a 150× Nikon objective) was used to produce a roughly 300×600 micrometer dataset. The dataset was further analyzed using the software package Digital Surf Mountains Map (Digital Surf, Besancon, France) to measure surface roughness parameters and to produce the 3-dimensional surface-plots of FIGS. 4A-4B and 5A-5C.

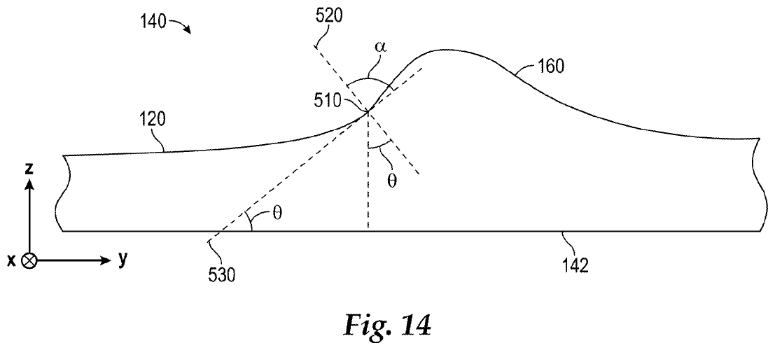

FIG. 14 is a schematic side-view of (micro)structure 160 of (micro)structured surface 120. Structure 160 has a slope distribution across the surface of the structure. For example, the microstructure has a slope θ at a location 510 where θ is the angle between normal line 520 which is perpendicular to the microstructure surface at location 510 (α=90 degrees) and a tangent line 530 which is tangent to the microstructure surface at the same location. Slope θ is also the angle between tangent line 530 and major surface 142 of the microstructured layer.

The slope of the (micro)structures, slope of the (micro)structured surface 120 was first taken along an x direction, and then along a y direction, such that:

$$X - slope = \frac{\partial H ( x , y )}{\partial x} , and \qquad Equation 1$$

$$Y - slope = \frac{\partial H ( x , y )}{\partial y} \qquad Equation 2$$

where, H(x,y)=the height profile of the surface.

Average x-slope and y-slope were evaluated in a 2 micron interval centered at each pixel. In different embodiments the micron interval may be chosen to be smaller or larger, so long as a constant interval is used with sufficient resolution for the microstructure size. The interval selected is less than the minimum peak width of the structure. In some embodiments, the ratio of the interval to the minimum peak width is at least 3:1, 4:1 or 5:1. Therefore, for smaller structures, smaller intervals would be selected and typically larger intervals for larger structures. Each pixel has a slope and each structure typically has more than one set of x, y coordinates and thus more than one calculated slope value. When a micro-sized interval is selected for evaluating the slope of a microstructured surface, the presence of nanostructures typically does not significantly change the Fcc of the microstructured surface. For example, a 200 nm nanostructure changes the coordinates of a 10 micron microstructure by 2%. From the x-slope and y-slope data, it is possible to determine a gradient magnitude from following Equation 3.

$$Gradient / Magnitude = \sqrt{{( \frac{\partial H ( x , y )}{\partial x} )}^{2} + {( \frac{\partial H ( x , y )}{\partial y} )}^{2}} \qquad Equation 3$$

Average gradient magnitude was then capable of being evaluated in a 6 μm×6 μm box centered at each pixel. Gradient magnitude was generated within a bin size of 0.5 degrees. Gradient magnitude distribution may be written as NG. It should be understood that in order to find the angle degree value of the x-slope, y-slope and gradient magnitude angles that corresponds to the values above, the arctangent of the values in Equations 1, 2, and 3 should be taken. Another characterization of the surface, is the Complement Cumulative Distribution (F_{CC}(θ)), defined as the fraction (or percentage by multiplying the fraction by 100%) of the gradient magnitudes that are greater than or equal to a particular angle θ. Complement Cumulative Distribution (F_{CC}(θ)), is defined as

$${F}_{CC} ( θ ) = \frac{{\sum }_{q = θ}^{∞} {N}_{G} ( θ )}{{{\sum }^{∞}}_{q = 0} {N}_{G} ( θ )} \qquad Equation 4$$

Therefore, when it is stated that a certain percentage of the structured surface has a slope magnitude that is less than a certain number of degrees, this characterization is derived from the Fcc(O) in Equation 4. Gradient magnitude corresponds to a combination of the x and y-slopes, and therefore, gradient magnitude may be understood as a general slope magnitude. It should be understood that the terms “gradient magnitude” and “slope magnitude” may be used interchangeably throughout this description and these terms should be understood to have the same meaning. When the total surface is microstructured, such as depicted by FIGS. 4A-4B and 5A-5C and the interval selected is less than the minimum peak width of the microstructures as previously described, the Fcc of the total surface is also the Fcc of the microstructured surface and the Fcc of the microstructures.

X-slope distributions (Xcc), Y-slope distributions (Yec) and F(cc) were calculated for embodied microstructured surfaces, as illustrated by FIGS. 4A-4B and 5A-5C.

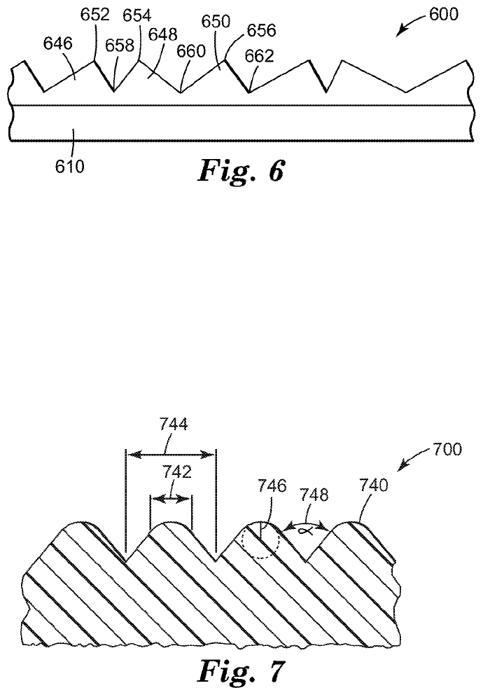

FIG. 8 is a plot of the complement of the cumulative gradient (i.e. slope) magnitude distribution (Fcc) that was calculated from the topographic data of the surfaces of FIGS. 4A-4B and 5A-5B as compared to comparative examples. Comparative Example A is a representative brightness enhancing film (e.g. Example 1 of WO2021/033162). Comparative Example D is a representative cube comer film (e.g. Example 20 of WO2021/033162). Notably, the microstructures of these comparative microstructured surfaces have a narrow distribution of slope. 90% of the microstructures of the surface of Comparative Example A and D have a slope of at least 30 degrees. 80% of the microstructures of the surface of Comparative Example A have a slope of at least 45 degrees (i.e. half the apex angle); whereas 80% of the microstructures of the microstructured surface of Comparative Example D have a slope of at least 40 degrees (i.e. half the apex angle) Less than 5% of the microstructures of both Comparative Example A and D have a slope less than 20 degrees. Further less than 5% of the microstructures have a slope greater than 50 degrees. For regular repeating patterns, such as Comparative Example A and D, the slope calculated from topographic data obtained from surface analysis can be substantially the same as the side wall angle as can be calculated from a cross section.

Notably, the surfaces illustrated by FIGS. 4A-4B and 5A-5C have a much broader distribution of slope. Notably, the structured surface comprises a plurality of structures having a complement cumulative slope magnitude distribution (Fee) such that at least 30, 40, 50, 60, 70, 80 or 90% of structures have a slope greater than 10 degrees. In contrast, the plurality of structures of the matte surface of Comparative Example C have a slope less than 20 degrees further, in some embodiments, less than 80% of the structures have a slope greater than 35 degrees. In some embodiments, the structured surfaces described herein, illustrated by FIGS. 4A-4B and 5A-5C, comprise a plurality of structures having a complement cumulative slope magnitude distribution (Fcc) that meet one or more of the following criteria:
a) at least 10, 20, 30, 40, 50, 60, 70 or 80% of structures have a slope greater than 20 degrees;
b) at least 10, 20, 30, 40, 50, 60, or 70% of structures have a slope greater than 30 degrees;
c) at least 10, 20, 30, 40 or 50% of structures have a slope greater than 40 degrees;
d) at least 10, 20, or 30% of structures have a slope greater than 50 degrees;
e) at least 10 or 20% of structures have a slope greater than 60 degrees;
f) less than 20, 10% of structures have a slope greater than 70 degrees;
g) less than 50, 40, 30 or 20% of structures have a slope greater than 60 degrees;
h) less than 50 or 40% of structures have a slope greater than 50 degrees;
i) less than 70, 60, or 50% of structures have a slope greater than 40 degrees;
j) less than 90 or 80% of structures have a slope greater than 30 degrees; and
k) less than 90% of structures have a slope greater than 20 degrees.

The complement cumulative slope magnitude distribution (Fcc) of FIG. 5C, i.e. the negative replication of FIG. 5B, can also be characterized by the same complement cumulative slope magnitude distribution (Fcc) criteria as just described. The structured surfaces, illustrated by FIGS. 4A-4B and 5A-5C, may be characterized by various combinations of the complement cumulative slope magnitude distribution (Fcc) criteria just described and in some embodiments all the criteria just described.

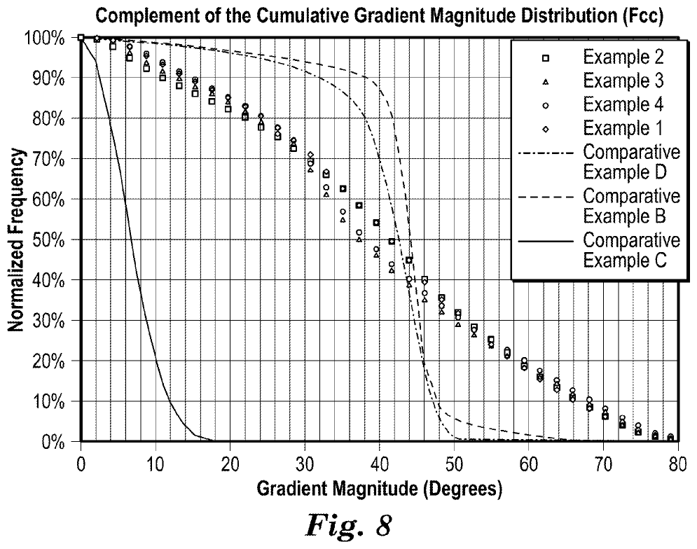

FIG. 9 is a plot of the complement of the cumulative gradient (i.e. slope) magnitude distribution (Ycc) of structured surfaces, illustrated by FIGS. 4A-4B and 5A-5B. These surfaces comprise a plurality of structures having a complement cumulative slope magnitude distribution (Ycc) wherein at least 20, 25, 30, 35, 40, 45, or 50% of the structures have a slope greater than 10 degrees and less than 55, 50, 45, 40, 35, 30, 25 or 20% of the structures have a slope greater than 30 degrees. In some embodiments, the structured surfaces described herein, illustrated by FIGS. 4A-4B and 5A-5B, comprise a plurality of structures having a complement cumulative slope magnitude distribution (Ycc) that meet one or more of the following criteria:
a) at least 10 or 20% of structures have a slope greater than 20 degrees;
b) at least 10 or 20% of structures have a slope greater than 30 degrees;
c) at least 10 or 15% of structures have a slope greater than 40 degrees;
d) at least 10% of structures have a slope greater than 50 degrees;
e) at least 5% of structures have a slope greater than 60 degrees;
f) less than 10 or 5% of structures have a slope greater than 70 degrees;
g) less than 20 to 10% of structures have a slope greater than 60 degrees;
h) less than 50, 40, 30, 20 or 10% of structures have a slope greater than 50 degrees;
i) less than 90, 80, 70, 60, 50, 40, 30 or 20% of structures have a slope greater than 40 degrees;
j) less than 90, 80, 70, 60, 50, 40, or 30% of structures have a slope greater than 20 degrees; and
k) less than 90, 80, 70, 60, 50, 40, or 30% of structures have a slope greater than 10 degrees.

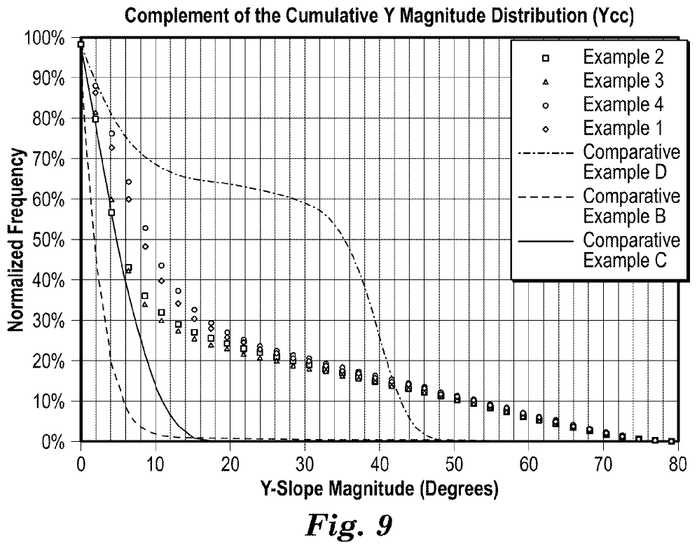

FIG. 10 is a plot of the complement of the cumulative gradient (i.e. slope) magnitude distribution (Xcc) of structured surfaces, illustrated by FIGS. 4A-4B and 5A-5B. These curfaces comprise a plurality of structures having a complement cumulative slope magnitude distribution (Xcc) wherein at least 45, 50, or 60% of the structures have a slope greater than 30 or 35 degrees; and less than 85 or 80% of the structures have a slope greater than 40 degrees. In some embodiments, the structured surfaces described herein, illustrated by FIGS. 4A-4B and 5A-5B, comprise a plurality of structures having a complement cumulative slope magnitude distribution (Xcc) that meet one or more of the following criteria:
a) at least 10, 20, 30, 40, 50, 60, 70 or 80% of structures have a slope greater than 10 degrees;
b) at least 10, 20, 30, 40, 50, 60, or 70% of structures have a slope greater than 20 degrees;
c) at least 10, 20, 30, 40, 50 or 60% of structures have a slope greater than 40 degrees;
d) at least 10 or 20% of structures have a slope greater than 50 degrees;
e) at least 10% of structures have a slope greater than 60 degrees;
f) less than 20, 10% of structures have a slope greater than 70 degrees;
g) less than 50, 40, 30 or 20% of structures have a slope greater than 60 degrees;
h) less than 50, 40, or 30% of structures have a slope greater than 50 degrees;
i) less than 90, 80, or 70% of structures have a slope greater than 30 degrees; and
j) less than 90 or 80% of structures have a slope greater than 20 degrees.

It is appreciated that the structured surface of FIG. 5C can also be characterized by the same complement cumulative slope magnitude distribution (Xcc) and (Ycc) criteria as just described.

Various other surface roughness parameters, Sa (Roughness Average), Sq (Root Mean Square), Sku (Surface Kurtosis), and Sbi (Surface Bearing Index), Svi (Valley Fluid Retention Index) were calculated from the topographic images (3D). Prior to calculating roughness, a plane correction was used “Subtract Plane” (1^{st} order planefit form removal).

The following table describes S parameters of some representative examples and comparative examples. Notably some of the comparative examples are also described in WO 2021/033151.

| | Sa | Sq | | | Sbi/ |
|---|---|---|---|---|---|
| Example | [nm] | [nm] | Sbi | Svi | Svi |
| Example 1 | 2613 | 3215 | 0.75 | 0.110 | 7 |
| Example 2 | 2445 | 2975 | 0.56 | 0.095 | 6 |
| Example 3 | 2893 | 3577 | 0.33 | 0.096 | 3 |
| Example 4 | 3549 | 4352 | 0.67 | 0.096 | 7 |
| Example 19 of WO2021/033162 | 1899 | 2215 | 0.53 | 0.086 | 6 |
| BEF epoxy | | | | | |
| Example 20 of WO2021/033162 | 10496 | 12504 | 0.97 | 0.039 | 25 |
| Cube Corner epoxy | | | | | |
| Example 1 of WO2021/033162 | 1961 | 2263 | 1.95 | 0.072 | 27 |
| BEF polymerized resin | | | | | |
| Example 6 of WO2021/033162 | 27327 | 32252 | 3.92 | 0.063 | 62 |
| Example 7 of WO2021/033162 | 5846 | 6620 | 2.80 | 0.064 | 44 |
| Example 8 of WO2021/033162 | 27289 | 32142 | 3.13 | 0.107 | 29 |
| Comp. B of WO2021/033162 | 366 | 457 | 0.28 | 0.092 | 3 |
| Smooth epoxy | | | | | |
| Comp. A of WO2021/033162 | 30 | 63 | 0.10 | 0.120 | 1 |
| Smooth Polymerized Resin | | | | | |
| Comp. E of WO2021/033162 | 41627 | 42389 | 7.1 | 0.017 | 417 |
| Square Wave | | | | | |
| Comp. F of WO2021/033162 | 21002 | 21428 | 1.22 | 0.013 | 95 |
| Square Wave | | | | | |

The Roughness Average, Saᵢ is defined as:

$${S}_{a} = \frac{1}{MN} {\sum }_{k = 0}^{M - 1} {\sum }_{l = 0}^{N - 1} \vert z ( {x}_{k} , {y}_{l} ) \vert$$

where M and N are the number of data points X and Y.

Although smooth surfaces can have a Sa approaching zero, the comparative smooth surfaces that were found to have poor microorganism removal after cleaning had an average surface roughness, Sa, of at least 10, 15, 20, 25 or 30 nm. The average surface roughness, Sa, of the comparative smooth surfaces was less than 1000 nm (1 micron). In some embodiments, Sa of the comparative smooth surface was at least 50, 75, 100, 125, 150, 200, 250, 300, or 350 nm. In some embodiments, Sa of the comparative smooth surface was no greater than 900, 800, 700, 600, 500, or 400 nm.

The average surface roughness, Sa, of the microstructured surfaces having improved microorganism removal after cleaning was 1 micron (1000 nm) or greater. In some embodiments, Sa was at least 1100 nm, 1200 nm, 1300 nm, 1400 nm, 1500 nm, 1600 nm, 1700 nm, 1800 nm, 1900 nm, or 2000 nm (2 microns). In some embodiments, Sa of the microstructured surfaces was at least 2500 nm, 3000 nm, 3500 nm, 4000 nm or 5000 nm. In some embodiments, Sa of the microstructured surfaces was at least 10,000 nm, 15,000 nm, 20,000 nm or 25,000 nm. In some embodiments, Sa of the microstructured surfaces having improved microorganism removal after cleaning was no greater than 40,000 nm (40 microns), 35,000 nm, 30,000 nm, 15,000 nm, 10,000 nm, or 5,000 nm.

In some embodiments, Sa of the microstructured surface is at least 2 or 3 times the Sa of a smooth surface. In other embodiments, Sa of the microstructured surface is at least 4, 5, 6, 7, 8, 9, or 10 times the Sa of a smooth surface. In other embodiments, Sa of the microstructured surface is at least 15, 20, 25, 30, 35, 40, 45, 50 times the Sa of a smooth surface. In other embodiments, Sa of the microstructured surface is at least 100, 200, 300, 400, 500, 600, 700, 800, 900, or 1000 times the Sa of a smooth surface.

### The Root Mean Square (RMS) Parameter Sq, is Defined as:

$${S}_{q} = \sqrt{\frac{1}{MN} {\sum }_{k = 0}^{M - 1} {\sum }_{l = 0}^{N - 1} {[ z ( {x}_{k} , {y}_{l} ) ]}^{2}}$$

where M and N are the number of data points X and Y.

Although the Sq values are slightly higher than the Sa values, the Sq values also fall within the same ranges just described for the Sa values.

The Surface Kurtosis, Sku, describes the “peakedness” of the surface topography, and is defined as:

$${S}_{ku} = \frac{1}{MN {S}_{q}^{4}} {\sum }_{k = 0}^{M - 1} {\sum }_{l = 0}^{N - 1} {[ z ( {x}_{k} , {y}_{l} ) ]}^{4} \qquad R4$$

| Example | Sku |
|---|---|
| Example 2 | 2.424 |
| Example 3 | 2.796 |
| Example 4 | 2.565 |
| Example 1 | 2.490 |
| Comparative Example D of WO2021/033162 | 2.390 |
| Comparative Example B of WO2021/033162 | 1.924 |
| Smooth epoxy | |
| Comparative Example A of WO2021/033162 | 1.786 |
| Smooth Polymerized Resin | |

Notably Examples 1-4 have a Sku greater than Comparative Example A, B, and D. In some embodiments, the Sku is greater than 2.40, 2.45, 2.50, 2.55, 2.60, 2.65, 2.70, or 2.75. In some embodiments, the Sku is less than 3.00, 2.95, 2.90, 2.85, 2.80, 2.75, 2.70, 2.65, 2.60 or 2.55, or 2.50, or 2.45.

The Surface Bearing Index, Sbi is defined as:

$${S}_{bi} = \frac{{S}_{q}}{{Z}_{0.05}} ,$$

wherein Z_{0.05} is the surface height at 5% bearing area.

### The Valley Fluid Retention Index, Svi, is Defined as:

$${S}_{vi} = \frac{{V}_{v} ( {h}_{0.8} )}{( M - 1 ) ( N - 1 ) δ x δ y} / {S}_{q} ,$$

wherein Vv(h0.80) is the void volume at valley zone within 80-100% bearing area.

As noted in the S Parameters table above, the Sbi/Svi ratio of the comparative smooth samples were 1 and 3. The microstructured surfaces having improved microorganism removal after cleaning had a Sbi/Svi ratio of 3 or greater than 3. The microstructured surfaces have a Sbi/Svi ratio of at least 4, 5, or 6. In some embodiments, the microstructured surfaces having improved microorganism removal after cleaning had a Sbi/Svi ratio of at least 7, 8, 9, or 10. In some embodiments, the microstructured surfaces having improved microorganism removal after cleaning had a Sbi/Svi ratio of at least 15, 20, 25, 30, 35, 40 or 45. The microstructured surfaces having improved microorganism removal after cleaning had a Sbi/Svi ratio of less than the comparative square wave microstructured surfaces. Thus, the microstructured surfaces having improved microorganism removal after cleaning had a Sbi/Svi ratio of less than 90, 85, 80, 75, 70 or 65. In some embodiments, the microstructured surfaces having improved microorganism removal after cleaning had a Sbi/Svi ratio of less than 60, 55, 50, 45, 40, 35, 30, 25, 20, or 10.

Topography maps can also be used to measure other features of the microstructured surface. For example, the peak height (especially of a repeating peak of the same height) can be determined from the height histogram function of the software. To calculate the percentage of “flat regions” of a square wave film, the “flat regions” can be identified using SPIP's Particle Pore Analysis feature, which identifies certain shapes (in this case, the “flat tops” of the microstructured square wave film.

The surface described herein is surmised to be a new engineered surface (i.e. not naturally occurring) regardless of the dimensions of the structures of the surface. In one embodiment, the surface may be a (e.g. decorative) macrostructured surface. A macro structured surface is typically visible without magnification by a microscope. In some embodiments, the average width of a macrostructure is at least 2, 3, 4, 5, 6, 7, 8, 9, or 10 mm. The average length of a macrostructure can be in the same range as the average width or can be significantly greater than the width. For example, when the macrostructure is a wood-grain macrostructure as commonly found on a door, the length of the macrostructure can extend the entire length of the (e.g. door) article. The height of the macrostructure is typically less than the width. In some embodiments, the height is less than 5, 4, 3, 2, 1, or 0.5 mm.

In other embodiments, the surface described herein as a microstructured surface. A microstructured surface comprises at least one (e.g. width or height) and typically at least two (e.g. width and height) have a dimension up to 1 mm.

In some embodiments, the microstructured surfaces comprising microstructures wherein the maximum width of the valleys is at least 1, 2, 3, or 4 microns and more typically greater than 5, 6, 7, 8, 9, or 10 microns ranging up to 250 microns. In some embodiments, the maximum width of the valleys is at least 11, 12, 13, 14, 15, 16, 17, 18, 19, 20, 21, 22, 23, 24, or 25 microns. In some embodiments, the maximum width of the valleys is at least 30, 35, 40, 45, or 50 microns. In some embodiments, the maximum width of the valleys is greater than 50 microns. In some embodiments, the maximum width of the valleys is at least 55, 60, 65, 70, 75, 85, 85, 90, 95 or 100 microns. In some embodiments, the maximum width of the valleys is at least 125, 150, 175, 200, 225, or 250 microns. Larger valley widths may better accommodate the removal of dirt. In some embodiments, the maximum width of the valleys is no greater than 1000, 950, 900, 850, 800, 750, 700, 650, 600, 550, 500, 450, 400, 350, 300, 250, 225, 200, 175, 150, 125, 100, 75, or 50 microns. In some embodiments, the maximum width of the valleys is no greater than 45, 40, 35, 30, 25, 20, or 15 microns. It is appreciated that the microstructured surface would be beneficial even when some of the valleys are less than the maximum width. For example, if half of the total number of valleys of the microstructured surface are within the desired range, about half the benefit may be obtained. Thus, in some embodiments, less than 50, 45, 40, 35, 30, 25, 20, 15, 10, 5 or 1% of the valleys have a maximum width of less than 10, 9, 8, 7, 6, or 5 microns. Alternatively at least 50, 60, 70, 80, 90, 95 or 99% of the valleys have a maximum width, as described above. In some embodiments, such as when microstuctured surface comprises valleys having different widths, the minimum and average width may fall within the dimensions just described.

In typical embodiments, the dimensions of the microstructures fall within the same ranges as described for the valleys. In other embodiments, the width of the valleys can be greater than the width of the microstructures.

The height of the microstructures (e.g. peaks) is within the same range as the maximum width of the valleys as previously described. In some embodiments, the peak structures typically have a height (H) ranging from 1 to 125 microns. In some embodiments, the height of the microstructures is at least 2, 3, 4, or 5 microns. In some embodiments, the height of the microstructures is at least 6, 7, 8, 9 or 10 microns. In some embodiments, the height of the microstructures no greater than 100, 90, 80, 70, 60, or 50 microns. In some embodiments, the height of the microstructures is no greater than 45, 40, 35, 30 or 25 microns. In some embodiments, the height of the microstructures is no greater than 24, 23, 22, 21, 20, 19, 18, 17, 16, 15, 14, 13, 12, 11, or 10 microns. In typical embodiments, the height of the valley or channel is within the same range as just described for the peak structures. In some embodiments, the peak structures and valleys have the same height. In other embodiments, the peak structures can vary in height. For example, when the microstructured surface is disposed on a macrostructured or microstructured surface, rather than a planar surface. When the peaks vary in height, the height of the peaks can be expressed as an average peak height. Thus, the average peak height may fall with the height criteria just described.

The aspect ratio of the valley is the height of the valley (which can be the same as the peak height of the microstructure) divided by the maximum width of the valley. In some embodiment the aspect ratio of the valley is at least 0.1, 0.15, 0.2, or 0.25. In some embodiments, the aspect ratio of the valley is no greater than 1, 0.9, 0.8, 0.7, 0.6 or 0.5. Thus, in some embodiments, the height of the valley is typically no greater than the maximum width of the valley, and more typically less than the maximum width of the valley.

The base of each microstructure may comprise various cross-sectional shapes including but not limited to paraellograms with optionally rounded corners, rectangles, squares, circles, half-circles, half-ellipses, triangles trapezoids, other polygons (e.g. pentagons, hexagons, octagons, etc. and combinations thereof.

In one embodiment, the microstructured surfaces described herein can provide a reduction in the presence of microorganisms after cleaning and/or a reduction in microorganism touch transfer.

The presently described microstructured surface typically does not prevent microorgansims (e.g. bacteria such as Streptococcus mutans, Staphyloccus aureus, Psueodomonas aeruginosa or Phi6 Bacteriophage) from being present on the microstructured surface or in other words does not prevent biofilm from forming. As evidenced in WO202133162, both smooth, planar surfaces and the microstructured surfaces described herein had about the same amount of microorganism (e.g. bacteria) present; i.e. in excess of 80 colony forming units, prior to cleaning. Thus, the presently described microstuctured surface would not be expected to be of benefit for sterile implantable medical devices.

However, as also evidenced by the forthcoming examples, the presently described microstructured surface is easier to clean, providing a low amount of microorganism (e.g. bacteria) present after cleaning. Without intending to be bound by theory, scanning electron microscopy images suggest that large continuous biofilms typically form on a smooth surface. However, even though the peaks and valleys are much larger than the microorganism (e.g. bacteria), the biofilm is interrupted by the microstructured surface. In some embodiments, the biofilm (before cleaning) is present as discontinuous aggregate and small groups of cells on the microstructured surface, rather than a continuous biofilm. After cleaning, biofilm aggregates in small patches cover the smooth surface. However, the microstructured surface was observed to have only small groups of cells and individual cells after cleaning. In favored embodiments, the microstructured surface provided a log 10 reduction of microorganism (e.g. bacteria such as Streptococcus mutans, Staphyloccus aureus, Psueodomonas aeruginosa, or Phi6 Bacteriophage) of at least 2, 3, 4, 5, 6, 7 or 8 after cleaning. In some embodiments, the microstructured surface had a mean log 10 of recovered colony forming units of microorganism of less than 6, 5, 4, or 3 after cleaning for a highly contaminated surface as prepared according to the test methods. Typical surfaces would often have a lower initial contamination and thus would be expected to have even less recovered colony forming units after cleaning. The test methods for these properties are described in the examples.

In some embodiments, the microstructured surface can prevent an aqueous or (e.g. isopropanol) alcohol-based cleaning solution from beading up as compared to a smooth surface comprised of the same polymeric (e.g. thermoplastic, thermoset, or polymerized resin) material. When a cleaning solution beads up or in other words dewets, the disinfectant agent may not be in contact with a microorganism for a sufficient duration of time to kill the microorganism. However, it has been found that at least 50, 60, 70, 80, or 90% of the microstructured surface can comprise cleaning solution 1, 2, and 3 minutes after applying the cleaning solution to the microstructured surface (according to the test method described in the examples).

In some embodiments, the microstructured surface provides a reduction in microorganism (e.g. bacteria such as Streptococcus mutans, Staphyloccus aureus, Psueodomonas aeruginosa, or Phi6 Bacteriophage) touch transfer. The reduction is microorganism touch transfer can be at least 25, 30, 35, 40, 45, 50, 60, 70, 80, 90, 95, or 99% in comparison to the same smooth (e.g. unstructured) surface. The test methods for this property is described in the examples.

As described in WO 2021/033151, when the side wall angle is too small, and/or the maximum width of the valley is too small, and/or the microstructured surface comprises an excess amount of flat surface area, the microstructured surface is more difficult to clean (e.g. microorganisms and dirt).

The microstructured surface may or may not comprise nanostructures.

Although smaller structures including nanostructures can prevent biofilm formation, the presence of a significant number of smaller valleys and/or valleys with insufficient side wall angles can impede cleanability including dirt removal. Further, microstructured surfaces with larger microstructures and valleys can typically be manufactured at a faster rate. Thus, in typical embodiments, each of the dimensions of the microstructures is at least 1, 2, 3, 4, 5, 6, 7, 8, 9, 10, 11, 12, 13, 14, or 15 microns or greater than 15 microns as previously described. Further, in some favored embodiments, none of the dimensions of at least 50, 60, 70, 80, 90, 95 or 99% microstructures are less than 15, 14, 13, 12, 11, 10, 9, 8, 7, 6, 5, 4, 3, 2, or 1 micron.

In some embodiments, the microstructured surface is typically substantially free of microstructures having a width less than 5, 4, 3, 2, or 1 micron, inclusive of nanostructures having a width less than 1 micron. Some examples of microstructured surfaces that further comprise nanostructures are described in previously cited WO 2012/058605. Nanostructures typically comprise at least one or two dimensions that do not exceed 1 micron (e.g. width and height) and typically one or two dimensions that are less than 1 micron. In some embodiments, all the dimensions of the nanostructures do not exceed 1 micron or are less than 1 micron.

By substantially free, it is meant that there are none of such microstructures present or that some may be present provided that the presence thereof does not detract from the (e.g. cleanability) properties as will subsequently described. Thus, the microstructured surface or microstructures thereof may further comprise nanostructures provided that the microstructured surface provides a reduction in the presence of microorganisms after cleaning and/or reduction in microorganism touch transfer, as described herein. Further, in this embodiment, the presence of smaller microstructures and/or nanostructures does not prevent or significantly reduce the formation of biofilm.

In some embodiments, the microstructured surface may further comprise nanostructures. Other microstructured surfaces further comprising nanostructures are known. For example, Zhang et al., US2013/0216784, describes superhydrophobic films that comprise flat faces spaced apart by valleys. The valleys and faces may be covered by nanostructures. The superhydrophobic film has a static water contact angle of at least 140, 145, or 145 degrees. Such nanostructures typically have an aspect ratio of at least 1:1, 2:1, 3:1, 4:1, 5:1 or 6:1. The ratio of nanostructures to microstructures, as illustrated in the drawings, is about 20:1.

In other embodiments, wherein the microstructured surface comprises little or no nanostructures, the ratio of nanostructures to microstructures is less than 20:1, 15:1, 10:1, 5:1, 4:1, 3:1, 2:1 or 1:1.

In other embodiments, the microstructured surface may further comprise randomly distributed recesses, as described in Aronson et al., WO2009/079275. The presence of the randomly distributed recesses improves the diffusion, as compared to the same microstructured surface lacking such recesses.

The presence of nanostructures and recesses can trap dirt, especially clay having a particle size less than 1 micron. However, the microstructured surface may comprise nanostructures and randomly distributed recesses for embodiments wherein the microstructured surface is utilized inside a display or other uses wherein the microstructured surface is not cleaned.

When the facets of the microstructures are joined such that the apex and valleys are sharp or rounded, but not truncated, the microstructured surface can be characterized are being free of flat surfaces, that are parallel to the planar base layer. However, wherein the apex and/or valleys are truncated, the microstructured surface typically comprises less than 50, 45, 40, 35, 30, 25, 20, 15, 10, 5 or 1% of flat surface area that is substantially parallel to the planar base layer. In one embodiment, the valleys may have flat surfaces and only one of the side walls of the peaks is angled such as shown in FIG. 2A. However, in favored embodiments, both side walls of adjacent peaks defining the valley(s) are angled toward each other, as previously depicted. Thus, the side walls on either side of a valley are not parallel to each other.

FIG. 9 of WO 2021/033151 depicts a comparative microstructured surface having discontinuous valleys. Such surface has also been described as having groupings of features arranged with respect to one another as to define a tortuous pathway. Rather, the valleys are intersected by walls forming an array of individual cells, each cell surrounded by walls. Some of the cells are about 3 microns in length; whereas other cells are about 11 microns in length.

In contrast, the valleys of the microstructured surfaces described herein are substantially free of intersecting side walls or other obstructions to the valley. By substantially free, it is meant that there are no side walls or other obstructions present within the valleys or that some may be present provided that the presence thereof does not detract from the cleanability properties as subsequently described. The valleys are typically continuous in at least one direction. This can facilitate the flow of a cleaning solution through the valley. Thus, the arrangement of peaks typically does not define a tortuous pathway.

### Methods

The microstructured films and articles can be formed by a variety of methods, including a variety of microreplication methods, not limited to, coating, casting and curing a polymerizable resin, injection molding, and/or compressing techniques. For example, microstructuring of the (e.g. engineered) surface can be achieved by at least one of (1) casting a molten thermoplastic using a tool having a microstructured pattern (i.e. thermoplastic extrusion), (2) coating of a fluid onto a tool having a microstructured pattern, solidifying the fluid, and removing the resulting film, (3) passing a thermoplastic film through a nip roll to compress against a tool having a microstructured pattern (i.e., embossing), and/or (4) contacting a solution or dispersion of a polymer in a volatile solvent to a tool having a microstructured pattern and removing the solvent, e.g., by evaporation.

The tool can be formed using any suitable additive and/or subtractive techniques known to those skilled in the art. The tool can be metallic, such as nickel, nickel-plated copper or brass, or can be a thermoplastic material that is stable under the polymerization conditions, and that preferably has a surface energy that allows clean removal of the polymerized material from the master. One or more the surfaces of the base film can optionally be primed or otherwise be treated to promote adhesion of the optical layer to the base.

In some embodiments, the tool is a metal tool prepared using cutting tool system 1000, as previously described. In some embodiments, the tool surface comprises a negative replication of modified linear prisms, as illustrated by FIGS. 4A-4B and 5A-5C. Positive and negative replications of the tool surface can be made using various other techniques such as electroplating or casting and curing a polymerizable resin onto the tool surface.

Additional information regarding materials and various processes for forming the (e.g. engineered) microstructured surface can be found, for example, in Halverson et al., PCT Publication No. WO 2007/070310 and US Publication No. US 2007/0134784; Hanschen et al., US Publication No. US 2003/0235677; Graham et al., PCT Publication No. WO2004/000569; Ylitalo et al., U.S. Pat. No. 6,386,699; Johnston et al., US Publication No. US 2002/0128578 and US Patent Nos. U.S. Pat. Nos. 6,420,622, 6,867,342, 7,223,364 and Scholz et al., U.S. Pat. No. 7,309,519.

In some embodiments, the microstructured surface is incorporated into at least a portion of the surface of an article. In this embodiment, the microstructured surface is typically formed during the manufacture of the article. In some embodiments, this is accomplished by molding of a (e.g. thermoplastic, thermosetting, or polymerizable) resin, compression molding of a (e.g. thermoplastic of thermosetting) sheet or thermoforming of a microstructured sheet.

In one embodiment, an article or component thereof, such as a cell phone case or housing can be prepared by casting a liquid (e.g. thermoplastic, thermosetting, or polymerizable) resin into a mold, wherein the mold surface comprises a negative replication of the microstructured surface.

In some embodiments, an article or component thereof can be formed by casting a liquid epoxy resin composition into a mold or compression molding of an epoxy resin sheet, as described in WO 2012058605; incorporated herein by reference.

### Method of Forming a Microstructured Film or Sheet

In some embodiments, the peak structures and (e.g. planar) base member comprise a different material. For example, as described in Lu et al., U.S. Pat. No. 5,175,030, and Lu, U.S. Pat. No. 5,183,597, a microstructure-bearing article (e.g. brightness enhancing film) can be prepared by a method including the steps of (a) preparing a polymerizable composition; (b) depositing the polymerizable composition onto a master negative microstructured molding surface in an amount barely sufficient to fill the cavities of the master; (c) filling the cavities by moving a bead of the polymerizable composition between a preformed base (such as a monolithic or multilayer e.g. PET film) and the master, at least one of which is flexible; and (d) curing the composition.

Such casting and curing method can be utilized to form a microstructured film. Such method can also be utilized to form a thermoformable microstructured base member (e.g. sheet or plate).

In one embodiment, a method of making an article is described comprising providing a base member (e.g. sheet or plate) comprising a microstructured surface. The base member comprises a thermoplastic of thermosettable material. The peak structures comprise a different material than the base member such that the peak structures have a melt temperature greater than the base member. The peak structures typically comprise a cured polymerizable resin. The method comprises thermoforming the microstructured base member (e.g. film, sheet or plate) into an article at a temperature below the melt temperature of the peak structures. In some embodiments, vacuum forming may be used in combination with thermoforming, also known as dual vacuum thermoforming (DVT). In some embodiments, the thermoformed article may be a three-dimensional shell, such as an oxygen mask or (e.g. interior) automotive trim part.

Useful base member materials include, for example, styrene-acrylonitrile, cellulose acetate butyrate, cellulose acetate propionate, cellulose triacetate, polyether sulfone, polymethyl methacrylate, polyurethane, polyester, polycarbonate, polyvinyl chloride, polystyrene, polyethylene naphthalate, copolymers or blends based on naphthalene dicarboxylic acids, polycyclo-olefins, polyimides, silicone and fluorinated films, and glass. Optionally, the base material can contain mixtures or combinations of these materials. In an embodiment, the base may be multi-layered or may contain a dispersed component suspended or dispersed in a continuous phase. An example of a useful PET films include photograde polyethylene terephthalate and MELINEX™ PET available from DuPont Films of Wilmington, Del. An example of a useful thermoformable material is polyethylene terephthalate (polyester with glycol) commercially available as VIVAK PETG. Such material is characterized by having a tensile strength ranging from 5000-10,000 psi (ASTM D638) and a flexural strength of 5,000 to 15,000 (ASTM D-790). Such material has a glass transition temperature of 178° F. (ASTM D-3418).

Various polymerizable resins have been described that are suitable for the manufacture of microstructured films. In typical embodiments, the polymerizable resin comprises at least one (meth)acrylate monomer or oligomer comprising at least two (meth)acrylate groups (e.g. Photomer 6210) and a (e.g. multi(meth)acrylate) crosslinker (e.g. HDDA). One representative polymerizable resin comprises PHOTOMER 6210 aliphatic urethane diacrylate oligomer (75 parts), SR238 1,6-hexanediol diacrylate (25 parts), and LUCIRIN TPO photoinitiator (0.5%).

In some embodiments, the (micro)structured surface layer alone or in combination with the planar base layer has a high transmission of visible light, typically greater than 85, 90, or 95%. In some embodiments, the (micro)structured surface layer alone or in combination with the planar base layer has a clarity of less than 10, 5, or 1. In some embodiments, the (micro)structured surface layer alone or in combination with the planar base layer has a gloss at 20 degrees of less than 10 or 5. In some embodiments, the (micro)structured surface layer alone or in combination with the planar base layer has a gloss at 85 degrees of less than 10 or 5. In other embodiments, the (micro)structured surface layer alone or in combination with the planar base layer may be opaque. Both the light transmissive and opaque embodiments may be colored and/or further comprise a printed graphic.

In alternative embodiments, the materials of the microstructures and (e.g. planar) base member may be chosen to provide specific optical properties in addition to the improved microorganism removal and/or reduced touch transfer described herein.

For example, in one embodiment, the (e.g. planar) base member may comprise a multilayer optical film comprising at least a plurality of alternating first and second optical layers collectively reflecting at least one of 0°, 30°, 45°, 60°, or 75° incident light angle at least 30 percent of incident ultraviolet light over at least a 30-nanometer wavelength reflection bandwidth in a wavelength range from at least 100 nanometers to 280 nanometers. Such multilayer optical films are described in WO2020/070589; incorporated herein by reference and are useful as a UV-C shield, UV-C light collimator and UV-C light concentrator. In some embodiments, the incident visible light transmission through at least the plurality of alternating first and second optical layers is greater than 30 percent over at least a 30-nanometer wavelength reflection bandwidth in a wavelength range from at least 400 nanometers to 750 nanometers. The first optical layer may comprise at least one polyethylene copolymer. The second optical layer may comprise at least one of a copolymer comprising tetrafluoroethylene, hexafluoropropylene, and vinylidene fluoride, a copolymer comprising tetrafluoro-ethylene and hexafluoropropylene, or perfluoroalkoxy alkane. The first optical layer may comprise titania, zirconia, zirconium oxynitride, hafnia, or alumina. The second optical layer may comprise at least one of silica, aluminum fluoride, or magnesium fluoride. In some embodiments, the microstructures together with the multilayer optical film provide a visible light transparent UV-C (e.g. reflective) protection layer or in other words a UV-C shield. UVC light can be used to disinfect surfaces, however these wavelengths can damage any organic material and causing unwanted discoloration. By combining the microstructured surfaces described herein with a UV-C shield, the surface can be cleaned with both UVC light and conventional cleaning method (e.g. wiping, scrubbing, and/or applying an antimicrobial solution) to disinfect the microstructured surface.

As shown in FIG. 3, a continuous land layer 360 can be present between the bottom of the channels or valleys and the top surface 331 of (e.g. planar) base member 310. In some embodiments, such as when the microstructured surface is prepared from casting and curing a polymerizable resin composition, the thickness of the land layer is typically at least 0.5, 1, 2, 3, 4, or 5 microns ranging up to 50 microns. In some embodiments, the thickness of the land layer is no greater than 45, 40, 35, 30, 25, 20, 15, or 10 microns. Depending on the elongation of the cured microstructured material and the thickness of the land layer, the land layer may fracture and thus become discontinuous when the microstructured film is stretched, especially during tensile and elongation testing.

In some embodiments, the microstructured surface (e.g. at least peak structures thereof) comprise an organic polymeric material with a glass transition temperature (as measured with Differential Scanning Calorimetry) of at least 25° C. In some embodiments, the organic polymeric material has a glass transition temperature of at least 30, 35, 40, 45, 50, 55 or 60° C. In some embodiments, the organic polymeric material has a glass transition temperature no greater than 100, 95, 90, 85, 80, or 75° C. In other embodiments, the microstructured surface (e.g. at least peak structure thereof) comprises an organic polymeric material with a glass transition temperature as measured with Differential Scanning Calorimetry) of less than 25° C. or less than 10° C. In at least some embodiments, the microstructures may be an elastomer. An elastomer may be understood as a polymer with the property of viscoelasticity (or elasticity) generally having suitably low Young's modulus and high yield strain as compared with other materials. The term is often used interchangeably with the term rubber, although the latter is preferred when referring to crosslinked polymers.

The organic polymeric material may also be filled with suitable organic or inorganic fillers and for certain applications the fillers are radioopaque.

In one embodiment, the microstructures or microstructured surface may be made of a curable, thermoset material. Unlike thermoplastic materials wherein melting and solidifying is thermally reversible; thermoset plastics cure after heating and therefore although initially thermoplastic, either cannot be remelted after curing or the melt temperature is significantly higher after being cured.

In some embodiments, the thermoset material comprise a majority of silicone polymer by weight. In at least some embodiments, the silicone polymer will be polydialkoxysiloxane such as poly(dimethylsiloxane) (PDMS), such that the microstructures are made of a material that is a majority PDMS by weight. More specifically, the microstructures may be all or substantially all PDMS. For example, the microstructures may each be over 95 wt. % PDMS. In certain embodiments the PDMS is a cured thermoset composition formed by the hydrosilylation of silicone hydride (Si—H) functional PDMS with unsaturated functional PDMS such as vinyl functional PDMS. The Si—H and unsaturated groups may be terminal, pendant, or both. In other embodiments the PDMS can be moisture curable such as alkoxysilane terminated PDMS.

In some embodiments, other silicone polymers besides PDMS may be useful, for example, silicones in which some of the silicon atoms have other groups that may be aryl, for example phenyl, alkyl, for example ethyl, propyl, butyl or octyl, fluororalkyl, for example 3,3,3-trifluoropropyl, or arylalkyl, for example 2-phenylpropyl. The silicone polymers may also contain reactive groups, such as vinyl, silicon-hydride (Si—H), silanol (Si—OH), acrylate, methacrylate, epoxy, isocyanate, anhydride, mercapto and chloroalkyl. These silicones may be thermoplastic or they may be cured, for example, by condensation cure, addition cure of vinyl and Si—H groups, or by free-radical cure of pendant acrylate groups. They may also be cross-linked with the use of peroxides. Such curing may be accomplished with the addition of heat or actinic radiation.

Other useful polymers for the microstructures or microstructured surface may be thermoplastic or thermosetting polymers including polyurethanes, polyolefins including metallocene polyolefins, low density polyethylene, polypropylene, ethylene methacrylate copolymer; polyesters such as elastomeric polyesters (e.g., Hytrel), biodegradable polyesters such as polylactic, polylactic/glycolic acids, copolymers of succinic acid and diols, and the like, fluoropolymers including fluoroelastomers, acrylic (polyacrylates and polymethacrylates).

Polyurethanes may be linear and thermoplastic or thermoset. Polyurethanes may be formed from aromatic or aliphatic isocyanates combined with polyester or polyether polyols or a combination thereof.

Representative fluoropolymers include for example polyvinyl fluoride (PVF), polyvinylidene fluoride (PVDF), ethylene tetrafluoroethylene (ETFE), copolymers of tetrafluorethylene, hexafluoropropylene, and vinylidene fluoride (THV), polyethylene copolymers comprising subunits derived from tetrafluoroethylene (TFE), hexafluoropropylene (HFP), and vinylidene fluoride (VDF), and fluorinated ethylene propylene (FEP) copolymers. Fluoropolymers are commercially available from Dyneon LLC, Oakdale, MN; Daikin Industries, Ltd., Osaka, Japan; Asahi Glass Co., Ltd., Tokyo, Japan, and E.I. duPont deNemours and Co., Willmington, DE.

In some embodiment, the microstructured film or microstructured surface layer comprises a multilayer film comprising a fluoropolymer as described in previously cited WO2020/070589. Such multilayer films are useful as a UV-C shield, UV-C light collimator and UV-C light concentrator. In other embodiments, the microstructured film or microstructured surface layer comprises a monolithic or multilayer fluoropolymer (e.g. protective) layer that is not useful as a UV-C shield, UV-C light collimator and UV-C light concentrator.

In some embodiments, the microstructures or microstructured surface may be modified such that the microstructured surface is more hydrophilic. The microstructured surface generally may be modified such that a flat organic polymer film surface of the same material as the modified microstructured surface exhibits an advancing or receding contact angle of 45 degrees or less with deionized water. In the absence of such modifications, a flat organic polymer film surface of the same material as the microstructured surface typically exhibits an advancing or receding contact angle of greater than 45, 50, 55, or 60 degrees with deionized water.

Any suitable known method may be utilized to achieve a hydrophilic microstructured surface. Surface treatments may be employed such as plasma treatment, vacuum deposition, polymerization of hydrophilic monomers, grafting hydrophilic moieties onto the film surface, corona or flame treatment, etc. For certain embodiments, the hydrophilic surface treatment comprises a zwitterionic silane, and for certain embodiments, the hydrophilic surface treatment comprises a non-zwitterionic silane. Non-zwitterionic silanes include a non-zwitterionic anionic silane, for instance.

In other embodiments, the hydrophilic surface treatment further comprises at least one silicate, for example and without limitation, comprising lithium silicate, sodium silicate, potassium silicate, silica, tetraethylorthosilicate, poly(diethoxysiloxane), or a combination thereof. One or more silicates may be mixed into a solution containing the hydrophilic silane compounds, for application to the microstructured surface.

Optionally, a surfactant or other suitable agent may be added to the organic polymeric composition that is utilized to form the microstructured surface. For example, a hydrophilic acrylate and initiator could be added to a polymerizable composition and polymerized by heat or actinic radiation. Alternatively, the microstructured surface can be formed from a hydrophilic polymers including homo and copolymers of ethylene oxide; hydrophilic polymers incorporating vinyl unsaturated monomers such as vinylpyrrolidone, carboxylic acid, sulfonic acid, or phosphonic acid functional acrylates such as acrylic acid, hydroxy functional acrylates such as hydroxyethylacrylate, vinyl acetate and its hydrolyzed derivatives (e.g. polyvinylalcohol), acrylamides, polyethoxylated acrylates, and the like; hydrophilic modified celluloses, as well as polysaccharides such as starch and modified starches, dextran, and the like.

Such hydrophilic surfaces have been described for use for fluid control films, as described in US20170045284; incorporated herein by reference.

### Optional Additives & Coatings

The organic polymeric material of the microstructured surface may contain other additives such as antimicrobial agents (including antiseptics and antibiotics), dyes, mold release agents, antioxidants, plasticizers, thermal and light stabilizers including ultraviolet (UV) absorbers, fillers, pigments and the like.

Suitable antimicrobials can be incorporated into or deposited onto the polymers. Suitable preferred antimicrobials include those described in US Publication Nos. 2005/0089539 and 2006/0051384 to Scholz et al. and US Publication Nos. 2006/0052452 and 2006/0051385 to Scholz. The microstructures of the present invention also may be coated with antimicrobial coatings such as those disclosed in International Application No. PCT/US2011/37966 to Ali et al.

In typical embodiments, the microstuctured surface is not prepared from a (e.g. fluorinated (e.g. fluoropolymer) or PDMS) low surface energy material and does not comprise a low surface energy coating, a material or coating that on a flat surface has a receding contact angle with water of greater than 90, 95, 100, 105, or 110 degrees. In this embodiment, the low surface energy of the material is not contributing to the cleanability. Rather, the improvement in cleaning is attributed to the features of the microstructured surface. In this embodiment, the microstructured surface is prepared from a material such that a flat surface of the material typically has a receding contact angle with water of less than 90, 85, or 80 degrees.

In other embodiments, a low surface energy coating may be applied to the microstructures. Exemplary low surface energy coating materials that may be used include materials such as hexafluoropropylene oxide (HFPO), or organosilanes such as, alkylsilane, alkoxysilane, acrylsilanes, polyhedral oligomeric silsequioxane (POSS) and fluorine-containing organosilanes, just to name a few. Examples of particular coatings known in the art may be found, e.g., in US Publication No. 2008/0090010, and commonly owned publication, US Publication No. 2007/0298216. For embodiments, that include a coating is applied to the microstructures, it may be applied by any appropriate coating method, such as sputtering, vapor deposition, spin coating, dip coating, roll-to-roll coating, or any other number of suitable methods.

It also is possible and often preferable in order to maintain the fidelity of the microstructures to include a surface energy modifying compound in the composition used to form the microstructures. In some embodiments, the bloom additive may retard or prevent crystallization of the base composition. Suitable bloom additives may be found, for example, in International Publication No. WO2009/152345 to Scholz et al. and U.S. Pat. No. 7,879,746 to Klun et al.

### Cleaning the Microstructured Surface

In one embodiment, a method of providing an article having a surface with increased microorganism (e.g. bacteria) removal when cleaned is described. The microstructured surface may be mechanically cleaned, for example by wiping the microstructured surface with a woven or non-woven material or scrubbing the microstructured surface with a brush. In some embodiments, the fibers of the woven or non-woven material have a fiber diameter less than the maximum width of the valleys. In some embodiments, the bristles of the brush have a diameter less than the maximum width of the valleys. Alternatively, the microstructured surface may be cleaned by applying water or an antimicrobial solution to the microstructured surface. Further, the microstructured surface can also be cleaned by (e.g. ultraviolet) radiation-based disinfection. Combinations of such cleaning technique can be used.

The antimicrobial solution may contain an antiseptic component. Various antiseptic components are known including for example biguanides and bisbiguanides such as chlorhexidine and its various salts including but not limited to the digluconate, diacetate, dimethosulfate, and dilactate salts, as well as combinations thereof, polymeric quaternary ammonium compounds such as polyhexamethylenebiguanide; silver and various silver complexes; small molecule quaternary ammonium compounds such as benzalkoium chloride and alkyl substituted derivatives; di-long chain alkyl (C8-C18) quaternary ammonium compounds; cetylpyridinium halides and their derivatives; benzethonium chloride and its alkyl substituted derivatives; octenidine and compatible combinations thereof. In other embodiments, the antimicrobial component may be a cationic antimicrobial or oxidizing agent such as hydrogen peroxide, peracetic acid, bleach.

In some embodiments, the antimicrobial component is a small molecule quaternary ammonium compounds. Examples of preferred quaternary ammonium antiseptics include benzalkonium halides having an alkyl chain length of C8-C18, more preferably C12-C16, and most preferably a mixture of chain lengths. For example, a typical benzalkonium chloride sample may be comprise of 40% C12 alkyl chains, 50% C14 alkyl chains, and 10% C16 alkyl chains. These are commercially available from numerous sources including Lonza (Barquat MB-50); Benzalkonium halides substituted with alkyl groups on the phenyl ring. A commercially avaible example is Barquat 4250 available from Lonza; dimethyldialkylammonium halides where the alkyl groups have chain lengths of C8-C18. A mixture of chain lengths such as mixture of dioctyl, dilauryl, and dioctadecyl may be particularly useful. Exemplary compounds are commercially available from Lonza as Bardac 2050, 205M and 2250 from Lonza; Cetylpyridinium halides such as cetylpyridinium chloride available from Merrell labs as Cepacol Chloride; Benzethonium halides and alkyl substituted benzethonium halides such as Hyamine 1622 and Hyamine 10 times. available from Rohm and Haas; octenidine and the like.

In one embodiment, the (e.g. disinfectant) antimicrobial solution kills enveloped viruses (e.g. herpes viruses, influenza, hepatitis B), non-enveloped viruses (e.g. papillomaviruses, norovirus, rhinovirus, rotovirus), DNA viruses (e.g. poxviruses), RNA viruses (e.g. coronaviruses, norovirus), retroviruses (e.g. HIV-1), MRSA, VRE, KPC, Acinetobacter and other pathogens in 3 minutes. The aqueous disinfectant solution may contain a 1:256 dilution of a disinfectant concentrate containing benzyl-C12-16-alkyldimethyl ammonium chlorides (8.9 wt. %) octyldecyldimethylammonium chloride (6.67 wt. %), dioctyl dimethyl ammonium chloride (2.67 wt. %), surfactant (5-10%), ethtyl alcohol (1-3 wt-%) and chealating agent (7-10 wt. %) adjusted to a pH of 1-3.

### Articles

Since an object of the invention is to provide an article having a surface with increased microorganism (e.g. bacteria) removal when cleaned, the article is typically not a (e.g. sterile) medical article such as nasal gastric tubes, wound contact layers, blood stream catheters, stents, pacemaker shells, heart valves, orthopedic implants such as hips, knees, shoulders, etc., periodontal implants, dentures, dental crowns, contact lenses, intraocular lenses, soft tissue implants (breast implants, penile implants, facial and hand implants, etc.), surgical tools, sutures including degradable sutures, cochlear implants, tympanoplasty tubes, shunts including shunts for hydrocephalus, post-surgical drain tubes and drain devices, urinary catheters, endotraecheal tubes, heart valves, wound dressings, other implantable devices, and other indwelling devices. In some embodiments, the article is also not an orthodontic appliance or orthodontic brackets.

The medical articles just described may be characterized as single use articles, i.e. the article is used once and then disgarded. The above articles may also be characterized as single person (e.g. patient) articles. Thus, such articles are typically not cleaned (rather than sterilized) and reused with other patients.

However, other types of medical articles are cleaned during normal use of the article and thus would benefit by having a surface with increased microorganism (e.g. bacteria) removal when cleaned. One representative article is a dental tray. A “dental tray” may include an article shaped to at least partially overlay one or more teeth, gums, or dental implants. In some embodiments, a dental tray has an arch shape. As used herein, the term “arch” refers to a semi-circular shape. For example, a dental tray may be a dental aligner (e.g. orthodontic aligner or retainer), a night guard, a mouth guard, a treatment tray, complete or partial dentures, a tooth cap, or the like. A dental aligner may allow for repositioning misaligned teeth for improved cosmetic appearances and/or dental function. A night guard may be worn by a user to prevent teeth 10 grinding. A mouth guard may be, for example, a sports mouth guard that may or may not be formed to a user's mouth with heat. A treatment tray may allow administration of a medication to oral surfaces, e.g., teeth whitening, remineralization, gum disease treatments, or the like. In some embodiments, the dental tray may provide aesthetic appeal by providing color (e.g. whitening). In another embodiment, the medical article may be a dental splint, a palatal expander, a sleep apnea oral appliance, or a nociceptive trigeminal inhibition tension suppression system (NTI-tss).

In other embodiments, the article may be a non-implantable medical diagnostic device or component thereof. As used herein medical diagnostic device refers to an instrument, apparatus, implement, machine, including any component, part, or accessory, that is intended for use in the diagnosis of disease or other conditions, or in the cure, mitigation, treatment, or prevention of disease, in man or other animals. Medical diagnostic devices generally do not achieve its primary intended purposes through chemical action within or on the body of man or other animals and is not dependent upon being metabolized for the achievement of its primary intended purposes.

In some embodiments, the medical diagnostic device comprises a sensor such as an optical sensor that utilizes properties of light or an acoustic sensor that utilizes properties of sound including the sense of hearing. One illustrative medical diagnostic device comprising an acoustic component is a stethoscope. Since the diaphragm comes in contact with multiple patients during normal use, it is preferred that at least the outer (e.g. skin-contacting) surface of the diaphragm comprises the microstructured surface as described herein. Other components of the stethoscope, such as the flexible or rigid tubing and ear tips may also optionally comprise the microstructured surface described herein. Another illustrative medical diagnostic device comprising an acoustic component is an ultrasound or a component thereof, such as a probe. In some embodiments, the inner and/or outer surface of the probe cap may comprise a microstructured surface, as described herein.

Other (e.g. non-implantable) medical diagnostic articles that would benefit by having a microstructured surface as described herein include for example various reusable medical diagnostic scopes including otoscopes (used to look into the ears), ophthalmoscopes (used to look into a patient eyes), esophageal stethoscope, endoscope, colonoscope, etc. pulse oximeter (monitors the oxygen saturation of a patient's blood and changes in blood volume in the skin), (e.g. digital finger) blood pressure monitors and (e.g. reusable or disposable) blood pressure cuffs, temperature probes including electronic thermometers (e.g. set for the specific part of the body being measured, such as the forehead, mouth, under the armpit, rectally, or the ear), sensors for monitoring moisture or sweat, as well as surfaces of magnetic resonance imaging (MRI), computerized tomography (CT), computerized axial tomography (CAT) scan and X-ray diagnostic articles.

Some medical articles that are typically non-sterile and cleaned during normal use are further described in patent application number PCT/IB2022/051004 (Attorney Docket No. 82415WO008) and WO2021/236429 (Attorney Docket 83075WO006); incorporated herein by reference. The articles and surfaces described herein include those where the microstructured surface is exposed to the surrounding (e.g. indoor or outdoor) environment and is subject to being touched or otherwise coming in contact with (e.g. multiple) people and/or animals, as well as other contaminants (e.g. dirt).

In some embodiments, the microstructured surface of the article, comes in direct (e.g. skin) contact with (e.g. multiple) people and/or animals during normal use of the article. In other embodiments, the microstructured surface may come is close proximity to (e.g. multiple) people/or animals in the absence of direct (e.g. skin) contact. However, since the microstructured surface comes in close proximity such article surfaces can easily be contaminated with microorganisms (e.g. bacteria) and are therefore cleaned to prevent the spreading of microorganisms to others.

Representative articles that would be cleaned during normal use and/or are amenable for use with a (e.g. removable) protective film or integrating the microstructured surface into the surface of the article include various interior or exterior surfaces or components of
a) surface or component of a vehicle (e.g. automobile, bus, train, airplane, boat, ambulances, ships) as well as motorized and non-motorized shared vehicles such as car, scooters and bicycles including head rests, dashboards, door panels, window shutter (e.g. of an airplane), gear shifter, seat belt buckle, instrument and button panels, (e.g. plastic) seat back trays and arm rests, railings, cabin siding, luggage compartment, steering wheels, handlebars;
b) housing and cases of an electronic device (e.g. phone, laptop, tablet, or computer) as well as keyboards and mouses (including mouse pads) and touchscreens, projectors, printers, remote control devices, locks, chargers (including cords & docking stations), fobs, video and arcade games, slot machines, automatic teller machines; (e.g. handheld) scanners, key cards, and point of sale electronic devices such as credit card readers, keypads, stylists, cash registers, barcode scanner, payment kiosks;
c) packaging film (e.g. for food or medical products) and polymeric shipping products including labels, mailers, boxes, totes, and bubble-wrap;
d) food preparation and dining surfaces, containers (including plates, bowls, cubs, water bottles) and films including galleys, carts, cutting boards, lunch boxes, thermos, appliances (e.g. microwave, stove, ovens, blenders, toasters, coffee makers, refrigerator including shelves and drawers), beverage dispensers, grills, utensils (e.g. especially handles thereof), menus, condiments bottles, salt & pepper shakers, table tops and chairs (especially for public dining in restaurants, dorms, nursing homes, and prisons), garbage and recyclable containers;
e) (e.g. non-sterile) surfaces of a medical, dental, or laboratory facility or medical, dental, or laboratory equipment (e.g. defibulators, ventilators and CPAPs (especially masks thereof), face shields, crutches, wheelchairs, bed rails, breast pump devices, IV pole and bags, curing lights (e.g. for dental materials), exam tables, (e.g. asthma) inhalers, surfaces of massage devices;
f) surfaces or components of furniture (e.g. desks, tables, chairs, seats and armrests);
g) handles (e.g. knob, pull, levers including locks) of articles including furniture, doors of buildings, turn styles, appliances, vehicles, shopping carts and baskets, exercise equipment, (e.g. cooking) utensils, tools, handlebars, levers of window blinds, microphone, luggage, etc.;
h) building surfaces (including escalators and elevators) such as doors, railings, walls, flooring, countertops, desktops, cabinets, lockers, windows (e.g. sills), door bells, electrical modulators (e.g. light switches, dimmers, and outlets including plates thereof);
i) surfaces and components of lavatories (e.g. sink, toilet surfaces (e.g. levers), drain caps, shower walls, bathtub, vanity, countertop);
j) surface or liner of a swimming pool or roofing material;
k) personal items including toothbrushes, eye glass frames, shoes, clothing, helmets, head bands, hard hats, headphones, footwear (e.g. shoes and boots), handbags, back packs;
l) articles for children including toys, pacifiers, bottles, teethers, car seats, cribs, changing tables, and playground equipment;
m) cleaning equipment (e.g. vacuum, mop, scrub brush, dusters, toilet bowl cleaners, plunger, brooms)
n) protective athletic and sports equipment (e.g. helmets, guards, balls for various sports including football, basketball, soccer, and golf);
o) exercise, spa, and salon (e.g. hair styling and nail) equipment (e.g. weights, yoga mats)
p) office and schools supplies and equipment including writing instruments (e.g. pencils, pens, markers), writable surfaces (including films and white boards), erasers, file folders, book and notebook covers, scanner and copy machines;
q) manufacturing surfaces and equipment including conveyor belts, control panels for machine operation (e.g. of an assembly line).

The microstructured surface is particularly advantageous for congregate living facilities such as military housing, prisons, dorms, nursing homes, apartments, hotels; public places such as offices, schools, arenas, casinos, bowling alleys, golf courses, arcades, gyms, salons, spas, shopping centers, airports, train stations; and public transportation.

In some embodiments, the film for application to vehicle or building surfaces etc. may be characterized as an architectural, decorative, or graphic film. Graphic films typically include patterns, images, or other visual indicia. The graphic film may be a printed film, or the graphic may be created by means other than printing. For example, the graphic film may be perforated reflective film with a patterned arrangement of perforations.

The graphic film be prepared by the various methods described herein. In some embodiments, the graphic film is prepared by embossing the surface of a (e.g. commercially available) graphic film. Exemplary (e.g. architectural) graphic films (lacking the microstructured surface described herein) are available under the trade designation “3M™ DI-NOC™ Architectural Finishes” by 3M Company, St. Paul, MN. Such films comprise an organic polymer layer such as previously described. In some embodiments, the organic polymer layer comprises polyvinyl chloride, polyurethane, or polyester. The organic polymer layer further comprises a design pattern having the appearance for example of wood, leather, metal, concrete, ceramic, as well as various (e.g. abstract) designs. The surface finish is typically matte or glossy. In some instances, the film may have a (e.g. visible) macrostructure, as previously described, in combination with the microstructures described herein.

Referring again to FIGS. 2-4 and 6, the presently described articles comprise an (e.g. engineered) microstructured surface (200, 300, 400, 600) disposed on a base member (210, 310, 410, 610). When the article is a film (e.g. sheeting), the base member is planar (e.g. parallel to reference plane 126). The thickness of the base member is typically at least 10, 15, 20, or 25 microns (1 mil) and typically no greater than 500 microns (20 mil) thickness. In some embodiments, the thickness of the base member is no greater than 400, 300, 200, or 100 microns. The width of the (e.g. film) base member may be is at least 30 inches (122 cm) and preferably at least 48 inches (76 cm). The (e.g. film) base member may be continuous in its length for up to about 50 yards (45.5 m) to 100 yards (91 m) such that the microstructured film is provided in a conveniently handled roll-good. Alternatively, however, the (e.g. film) base member may be individual sheets or strips (e.g. tape) rather than as a roll-good.

Thermoformable microstructured base members typically having a thickness of at least 50, 100, 200, 300, 400, or 500 microns. Thermoformable microstructured base members may have thickness up to 3, 4, or 5 mm or greater.

When the article is a three-dimensional object, the base member may be planar such as in the case of a seat back tray. In other embodiments, the three-dimensional base member may be non-planar, having a curved surface or a surface with a complex topography, such as in the case of a toy.

The base member can be formed from various materials such as metal, alloy, organic polymeric material, or a combination comprising at least one of the foregoing. Specifically, glass, ceramic, metal or polymeric materials may be appropriate, as well as other suitable alternatives and combinations thereof such as ceramic coated polymers, ceramic coated metals, polymer coated metals, metal coated polymers and the like. The base member can, in some implementations, include discrete pores and/or pores in communication. The thickness of the base member can vary depending on the use.

The organic polymeric materials of the base member can be the same organic polymeric materials (e.g. thermoplastic, thermoset) previously described for the microstructured surface. In addition, fiber- and/or particle-reinforced polymers can also be used.

Non-limiting examples of suitable non-biodegradable polymers for planar or non-planar base members include polyolefins (e.g. polyisobutylene copolymers), styrenic block copolymers (e.g. styrene-isobutylene-styrene block copolymers, such as styrene-isobutylene-styrene tert-block copolymers (SIBS); polyvinylpyrrolidone including cross-linked polyvinylpyrrolidone; polyvinyl alcohols; copolymers of vinyl monomers such as EVA and polyvinyl chloride (PVC); polyvinyl ethers; polyvinyl aromatics; polyethylene oxides; polyesters such as polyethylene terephthalate; polyamides; polyacrylamides; polyethers such as polyether sulfone; polyolefins such as polypropylene, polyethylene, highly crosslinked polyethylene, and high or ultra high molecular weight polyethylene; polyurethanes; polycarbonates; silicones; siloxane polymers; natural based polymers such as optionally modified polysaccharides and proteins including, but not limited to, cellulosic polymers and cellulose esters such as cellulose acetate; and combinations comprising at least one of the foregoing polymers. Combinations may include miscible and immiscible blends as well as laminates.

The base (e.g. planar or non-planar) member may be comprised of a biodegradable material. Non-limiting examples of suitable biodegradable polymers include polycarboxylic acid; polyanhydrides such as maleic anhydride polymers; polyorthoesters; poly-amino acids; polyethylene oxide; polyphosphazenes; polylactic acid, polyglycolic acid, and copolymers and mixtures thereof such as poly(L-lactic acid) (PLLA), poly(D,L,-lactide), poly(lactic acid-co-glycolic acid), and 50/50 weight ratio (D,L-lactide-co-glycolide); polydioxanone; polypropylene fumarate; polydepsipeptides; polycaprolactone and co-polymers and mixtures thereof such as poly(D,L-lactide-co-caprolactone) and polycaprolactone co-blutylacrylate; polyhydroxybutyrate valerate and mixtures thereof; polycarbonates such as tyrosine-derived polycarbonates and arylates, polyiminocarbonates, and polydimethyltrimethylcarbonates; cyanoacrylate; calcium phosphates; polyglycosaminoglycans; macromolecules such as polysaccharides (including hyaluronic acid, cellulose, and hydroxypropylmethyl cellulose; gelatin; starches; dextrans; and alginates and derivatives thereof, proteins and polypeptides; and mixtures and copolymers of any of the foregoing. The biodegradable polymer can also be a surface erodible polymer such as polyhydroxybutyrate and its copolymers, polycaprolactone, polyanhydrides (both crystalline and amorphous), and maleic anhydride.

In some embodiments, the microstructured surface may be integrated with at least a portion of the article or component thereof. In other embodiments, the (e.g. engineered) microstructured surface may be provided as a film or tape and affixed to the base member. In such embodiments, the microstructures may be made of the same or different material base member. Fixation may be provided using mechanical coupling, an adhesive, a thermal process such as heat welding, ultrasonic welding, RF welding and the like, or a combination thereof.

In some embodiments, the (e.g. planar) base member as well as microstructured film is flexible. In some embodiments, the (e.g. graphic) film is sufficiently flexible and conformable such that the film can be applied (e.g. bonded with an adhesive) to a complex curved (e.g. three-dimensional) surface. In some embodiments, the (e.g. planar) base member as well as microstructured film has an elongation of at least 25, 50, 75, 100, 125, 150, or 200%. In some embodiments, the (e.g. planar) base member as well as microstructured film has an elongation of no greater than 750, 700, 650, 600, 550, 500, 450, 400, 350, 300, or 250%. In some embodiments, the (e.g. planar) base member as well as microstructured film has a tensile modulus of no greater than 1000, 750, 500 MPa. The tensile modulus is typically at least 100, 150, or 200 MPa. In some embodiments, the (e.g. planar) base member as well as microstructured film has a tensile strength of no greater than 70, 65, 60, 55, 50, 45, 40, 35, or 30 MPa. The tensile strength is typically at least 5, 10, 15, 20, 25, or 30 MPa. In some embodiments, tensile testing is determined according to ASTM D882-10 with an initial grip distance of 1 inch and a speed of 1 inch/min or 100% strain/min. In other embodiments, tensile and elongation properties are determined according to ASTM D3759-05 at a rate of 12 inches/min (as further described in the examples).

In some embodiments, the flexible planar base layer or microstructured film may be characterized as conformable, having a sufficiently high elongation in combination with a low tensile strength. Conformable planar base layers and microstructured films may also be characterized as having a load of less than 50 Newtons at a fixed extension of 0.25 inches. The load at a fixed extension of 0.25 inches is typically at least 5 or 10 Newtons. In some embodiments, the load at a fixed extension of 0.25 inches is no greater than 45, 40, 35, 30, 25, 20, 15 or 10 Newtons.

The flexible (e.g. conformable) planar base layer film can be formed of various material. Suitable materials include for example polyurethane; polyvinyl chloride (PVC); polyolefins and olefin copolymers including for example low density polyethylene, polypropylene, ethylene vinyl acetate (EVA) and ethylene acrylic acid (EAA); (meth)acrylic films; and polyesters such as polylactic acid based polymers and PETg. In some embodiments, the planar base layer film may comprise a biodegradable polymer. The planar base layer can also be a multilayered film comprising two or more layers of such polymers. In addition, fiber- and/or particle-reinforced polymers can also be used.

The tensile and elongation properties of various materials and films are reported in the literature or can be measured using the ASTM teat method described above.

When the microstructures comprise a “harder” less flexible material (e.g. cast and cured) on a flexibles planar base layer film. In this embodiment, the planar base layer film has an elongation greater than the elongation of the microstructured film. In other words, the elongation of the microstructured film is less than the elongation of the planar bae layer film. In some embodiments, the microstructured film has an elongation of no greater than 450, 400, 350, 300, or 250%. In some favored embodiments, the microstructured film has an elongation of no greater than 250, 225, 200, 175, 150, 125, or 100%. In some embodiments, the elongation of the microstructured film is at least 25, 30, 35, 40, or 50%

In some embodiments, the microstructured film having a flexible planar base layer has a tensile strength of no greater than 160, 150, 140, or 130 MPa. In some favored embodiments, the microstructured film has a tensile strength of no greater than 125, 100, 75 or 50 MPa. In some embodiments, the tensile strength is at least 10, 15, 20, 25 or 30 MPa.

Although the presence of the microstructured surface layer can decrease the elongation and/or tensile strength of the planar base layer, the microstructured film can be sufficiently flexible (e.g. conformable) while improving the replication fidelity and durability of the microstructured surface.

In one embodiment, a film (e.g. tape) comprising a microstructured surface disposed on a planar base layer as described herein is provided. The film (e.g. tape) comprises a pressure sensitive adhesive (e.g. 350 of FIG. 3) on the opposing surface of the film. A microstuctured surface can be provided on a surface or article by providing the adhesive-coated film and bonding the film to the surface or article with the (e.g. pressure sensitive) adhesive.

The base (e.g. planar or non-planar) member may be subjected to customary surface treatments for better adhesion with the adjacent (e.g. pressure sensitive) adhesive layer. Additionally, the base member may be subjected to customary surface treatments for better adhesion of the (e.g. cast and cured) microstructured layer to an underlying base member. Surface treatments include for example exposure to ozone, exposure to flame, exposure to a high-voltage electric shock, treatment with ionizing radiation, and other chemical or physical oxidation treatments. Chemical surface treatments include primers. Examples of suitable primers include chlorinated polyolefins, polyamides, and modified polymers disclosed in U.S. Pat. Nos. 5,677,376, 5,623,010 and those disclosed in WO 98/15601 and WO 99/03907, and other modified acrylic polymers. In one embodiment, the primer is an organic solvent based primer comprising acrylate polymer, chlorinated polyolefin, and epoxy resin as available from 3M Company as “3M™ Primer 94”.

The microstructured film may comprise various (e.g. pressure sensitive) adhesives such as natural or synthetic rubber-based pressure sensitive adhesives, acrylic pressure sensitive adhesives, vinyl alkyl ether pressure sensitive adhesives, silicone pressure sensitive adhesives, polyester pressure sensitive adhesives, polyamide pressure sensitive adhesives, poly-alpha-olefins, polyurethane pressure sensitive adhesives, and styrenic block copolymer based pressure sensitive adhesives. Pressure sensitive adhesives generally have a storage modulus (E′) as can be measured by Dynamic Mechanical Analysis at room temperature (25° C.) of less than 3×10⁶ dynes/cm at a frequency of 1 Hz.

The (e.g. pressure sensitive) adhesives may be organic solvent-based, a water-based emulsion, hot melt (e.g. such as described in U.S. Pat. No. 6,294,249), as well as an actinic radiation (e.g. e-beam, ultraviolet) curable (e.g. pressure sensitive) adhesive.

In some embodiments, the adhesive layer is removable. A removable adhesive cleanly removes from a substrate or surface (e.g. glass or polypropylene panels) to which it is temporarily bonded after aging at 50, 60, 70, 80, 90, 100 or 120° C. (248° F.) for 4 hours and then equilibrated to 25° C. at a removal rate of about 20 inches/minute.

In some embodiments, the adhesive layer is a repositionable adhesive layer. The term “repositionable” refers to the ability to be, at least initially, repeatedly adhered to and removed from a substrate without substantial loss of adhesion capability. A repositionable adhesive usually has a peel strength, at least initially, to the substrate surface lower than that for a conventional aggressively tacky PSA. Suitable repositionable adhesives include the adhesive types used on CONTROLTAC Plus Film brand and on SCOTCHLITE Plus Sheeting brand, both made by 3M Company, St. Paul, Minnesota, USA.

The adhesive layer may also be a structured adhesive layer or an adhesive layer having at least one microstructured surface. Upon application of film article comprising such a structured adhesive layer to a substrate surface, a network of channels or the like exists between the film article and the substrate surface. The presence of such channels or the like allows air to pass laterally through the adhesive layer and thus allows air to escape from beneath the film article and the surface substrate during application.

The release liner typically comprises paper or film, which has been coated or modified with compounds of low surface energy such as organosilicone compounds, fluoropolymers, polyurethanes and polyolefins. The release liner can also be a polymeric sheet produced from polyethylene, polypropylene, PVC, polyesters with or without the addition of adhesive-repellant compounds. As mentioned above, the release liner may have a microstructured or micro-embossed pattern for imparting a structure to the adhesive layer. A microstructured release liner may also be used to impart the microstructured surface and protect the microstructured surface from damage prior and during application of a microstructured layer to a target surface or article.

The adhesive layer can be adhered to various surfaces as previously described. The surface may comprise wood, metal, as well as various organic polymeric materials. The film is the absence of adhesive may also be suitable for use as a textile (e.g. synthetic leather) for furniture and clothing.

Further details regarding the adhesive are described in WO 2021/033151; incorporated herein by reference.

The term “microorganism” is generally used to refer to any prokaryotic or eukaryotic microscopic organism, including without limitation, one or more of bacteria (e.g., motile or nonmotile, vegetative or dormant, Gram positive or Gram negative, planktonic or living in a biofilm), bacterial spores or endospores, algae, fungi (e.g., yeast, filamentous fungi, fungal spores), mycoplasmas, and protozoa, as well as combinations thereof. In some cases, the microorganisms of particular interest are those that are pathogenic, and the term “pathogen” is used to refer to any pathogenic microorganism. Examples of pathogens can include, but are not limited to, both Gram positive and Gram negative bacteria, fungi, and viruses including members of the family Enterobacteriaceae, or members of the family Micrococaceae, or the generafcc Staphylococcus spp., Streptococcus, spp., Pseudomonas spp., Acinetobacter spp., Enterococcus spp., Salmonella spp., Legionella spp., Shigella spp., Yersinia spp., Enterobacter spp., Escherichia spp., Bacillus spp., Listeria spp., Campylobacter spp., Acinetobacter spp., Vibrio spp., Clostridium spp., Klebsiella spp., Proteus spp. Aspergillus spp., Candida spp., and Corynebacterium spp. Particular examples of pathogens can include, but are not limited to, Escherichia coli including enterohemorrhagic E. coli e.g., serotype O157:H7, O129:H11; Pseudomonas aeruginosa; Bacillus cereus; Bacillus anthracis; Salmonella enteritidis; Salmonella enterica serotype Typhimurium; Listeria monocytogenes; Clostridium botulinum; Clostridium perfringens; Staphylococcus aureus; methicillin-resistant Staphylococcus aureus; carbapenem-resistant Enterobacteriaceae, Campylobacter jejuni; Yersinia enterocolitica; Vibrio vulnficus; Clostridium difficile; vancomycin-resistant Enterococcus; Klebsiella pnuemoniae; Proteus mirabilus and Enterobacter [Cronobacter] sakazakii.

Advantages of this invention are further illustrated by the following examples, but the particular materials and amounts thereof recited in these examples, as well as other conditions and details, should not be construed to unduly limit this invention. Unless otherwise indicated, all parts and percentages are by weight.

### EXAMPLES

### Materials and Methods

| Abbreviation | Description and Source |
|---|---|
| TWEEN 20 | Polyethylene glycol sorbitan monolaurate non-ionic detergent |
| | (Sigma-Aldrich Company, St. Louis, MO |
| PBS | Phosphate buffered saline (Thermo Fischer Scientific, Waltham, MA) |
| MELINEX 618 | MELINEX 618 PET film (DuPont Teijin Films, Chester, VA) |
| SONTARA | Polyethylene terephthalate (PET) nonwoven sheet (12 micron fiber |
| 8000 | diameter, 40 gsm) (Jacob Holm Group, Basel, Switzerland) |
| PHOTOMER | Aliphatic urethane diacrylate oligomer (IGM Resins, Charlotte, NC) |
| 6210 | |
| SR238 | 1,6-Hexanediol diacrylate, obtained from Sartomer, Exton, PA |
| LUCIRIN TPO | Photoinitiator (BASF Corporation, Florham Park, NJ) |

### UV Curable Resin

The UV curable resin was prepared from PHOTOMER 6210 aliphatic urethane diacrylate oligomer (75 parts), SR238 1,6-hexanediol diacrylate (25 parts), and LUCIRIN TPO photoinitiator (0.5%). The components were blended in a high speed mixer, heated in an oven at about 70° C. for 24 hours) and then cooled to room temperature.

### Bacterial Cultures

Tryptic Soy Broth (TSB, obtained from Becton, Dickinson and Company, Franklin Lakes, NJ) was dissolved in deionized water and filter-sterilized according to the manufacturer's instructions.

A streak plate of Pseudomonas aeruginosa (ATCC 15442) was prepared from a frozen stock on Tryptic Soy Agar. The plate was incubated overnight at 37° C. A single colony from the plate was transferred to 10 mL of sterile TSB. The culture was shaken overnight at 250 revolutions per minute and 37° C. Inoculation samples were prepared by diluting the culture (about 109 colony forming units (cfu)/mL) 1:100 in TSB.

### Casting Procedure for Preparing Microstructured Films

UV curable resin (described above) was coated onto a polyethylene terephthalate (PET) support film using a slot die. The resin-coated film was brought into contact with a tool having a microstructured surface using pressure provided by a rotating nip roll. While the resin was in contact with the tool, the resin was cured using a high intensity Fusion Systems “D” lamp (from Fusion UV Curing Systems, Rockville, MD) with UV-A (315-400 nm) in the range of 100-1000 mJ/cm².

### Control Film

A UV curable resin was prepared from PHOTOMER 6210 aliphatic urethane diacrylate oligomer (75 parts), SR238 1,6-hexanediol diacrylate (25 parts), and LUCIRIN TPO photoinitiator (0.5%). The components were blended in a high speed mixer, heated in an oven at about 70° C. for 24 hours, and then cooled to room temperature. A copper button (about 2 inch (5.08 cm) diameter) with a smooth (i.e., non-microstructured) surface was used to prepare the film. The button and the compounded resin were both heated in an oven at about 70° C. for 15 minutes. Approximately six drops of warmed UV curable resin (described above) were applied using a transfer pipette to the center of the warmed button. A section of MELINEX 618 PET support film [3 inch by 4 inch (7.62 cm by 10.16 cm), 5 mil thick] was placed over the applied resin followed by a glass plate. The primed surface of the PET film was oriented to contact the resin. The glass plate was held in place with hand pressure until the resin completely covered the surface of the button. The glass plate was carefully removed. If any air bubbles were introduced, a rubber hand roller was used to remove them.

The sample was cured with UV light by passing the sample 2 times through a UV processor (model QC 120233AN with two Hg vapor lamps, obtained from RPC Industries, Plainfield, IL) at a rate of 15.2 meters/minute (50 feet/minute) under a nitrogen atmosphere. The cured film having a smooth resin surface was removed from the copper template by gently pulling away at a 90° angle. Alternatively, larger sections of film were prepared by a cast and cure method with the UV curable resin coated onto the PET film, nipped to a smooth roll, and then cured with UV light.

### Comparative Example a and Comparative Example B Films

The linear prism microstructured films of Comparative Example A and Comparative Example B were prepared according to the procedures described in Example 1 and Example 2, respectively, of PCT Publication No. WO 2021/033162 (Connell). A release liner backed adhesive layer was not applied to films used for scratch visualization, transmission, clarity, gloss, and luminance profile measurements. The features of the microstructured films are reported in Table 1.

TABLE 1

| | | Maximum | | | | |
|---|---|---|---|---|---|---|
| Linear Prism | Peak | Valley | Apex | Valley | Side Wall | Apex |
| Microstructured | Height | Width | Angle | Angle | Angle | (Radius of |
| Film | (microns) | (microns) | (degrees) | (degrees) | (degrees) | Curvature) |
| Comparative | 6.6 | 17 | 95 | 95 | 47.5 | sharp |
| Example A | | | | | | |
| Comparative | 6.0 | 24 | 91 | 91 | 45.5 | sharp |
| Example B | | | | | | |

Sample Disc Inoculation. Incubation and Washing Method

A release liner backed adhesive layer (8 mil thick, obtained as 3M 8188 Optically Clear Adhesive from the 3M Corporation, St. Paul, MN) was applied to the back surface (i.e., non-resin coated surface) of the PET support film using a hand roller. A 34 mm diameter hollow punch was used to cut out individual discs from the microstructured films and the Control Film. A single disc was placed in each well of a sterile 6-well microplate and oriented so that the microstructured surface of the disc faced the well opening and the release liner faced the well bottom. The plate was then sprayed with a mist of isopropyl alcohol to disinfect the samples and allowed to dry.

Inoculation samples (4 mL) of the P. aeruginosa culture (described above) were added to each well of the 6-well microplate containing a disc. The lid was placed on the 6-well microplate and the plate was wrapped in PARAFILM M laboratory film (obtained from the Bemis Company, Oshkosh, WI). The wrapped plate was inserted in a plastic bag containing a wet paper towel and the sealed bag was placed in an incubator at 37° C. After 7 hours, the plate was removed from the incubator and the liquid media was removed from each well using a pipette. Fresh, sterile TSB (4 mL) was added to each well and the plate lid was attached. The plate was re-wrapped in PARAFILM M laboratory film, sealed in a bag with a wet paper towel, and returned to the incubator. After 17 hours, the plate was removed from the incubator. The liquid media was removed from each well (using a pipette) and replaced with 4 mL of sterile, deionized water. The water was removed and replaced with 4 mL portions of sterile, deionized water two additional times. The final water portion was removed from each well and then the discs were removed. The liner layer was peeled from each disc to expose the adhesive backing. Smaller 12.7 mm diameter discs were cut from each disc using a hollow punch. Some of the discs (n=3) were analyzed for colony count (cfu) on the disc and some of the discs (n=3) were carried on to the cleaning procedure step.

### Sample Disc Cleaning Procedure

Each 12.7 mm diameter disc was attached through the adhesive backing of the disc to a cleaning lane of an Elcometer Model 1720 Abrasion and Washability Tester (Elcometer Incorporated, Warren, MI). Two different types of wetted wipes (5.08 cm by 12.7 cm) were used in the test. The first wetted wipe was a SONTARA 8000 nonwoven sheet soaked in a solution containing TWEEN 20 (0.05%) in deionized water. The second wetted wipe was a WypALL L30 General Purpose Wiper (obtained from the Kimberly-Clark Corporation, Irving, TX) soaked with deionized water that contained PALMOLIVE soap (Colgate-Palmolive Company, New York, NY) (1 drop per 50 mL of water). Excess liquid was removed from all wipes by hand squeezing liquid from each wipe. Each wetted wipe was individually secured around the Universal Material Clamp Tool (450 g) and the tool was attached to the carriage of the instrument. The instrument was set to operate with 15 carriage cycles at a rate of 60 cycles/minute (total cleaning time=15 seconds).

### Sample Disc Colony Count Method

Following the cleaning procedure, each disc was washed five times with 1 mL portions of a solution containing TWEEN 20 (0.05%) in PBS buffer. Each washed disc was individually transferred to a separate 50 mL conical vial that contained a solution of TWEEN 20 (0.05%) in PBS buffer (10 mL). Each tube was sequentially vortexed for 1 minute, sonicated for 1 minute using a Branson 2510 Ultrasonic Cleaning Bath (Branson Ultrasonics, Danbury, CT), and then vortexed for 1 minute. The solution from each tube was serially diluted (about 8 dilutions) with Butterfield's buffer (obtained from the 3M Corporation) to yield a P. aeruginosa concentration level that provided counts of colony forming units (cfu) within the counting range of a 3M PETRIFILM Aerobic Count Plate (3M Corporation). An aliquot (1 mL) from each diluted sample was plated on a separate 3M PETRIFILM Aerobic Count Plate according to the manufacturer's instructions. The count plates were incubated at 37° C. for 48 hours. After the incubation period, the number of cfu on each plate was counted using a 3M PETRIFILM Plate Reader (3M Corporation). The count value was used to calculate the total number of cfu recovered from a disc. The results are reported as the mean cfu count determined for 3 discs. Discs that were not subjected to the cleaning procedure were analyzed for colony count (cfu) using the same described procedure.

### Example 1

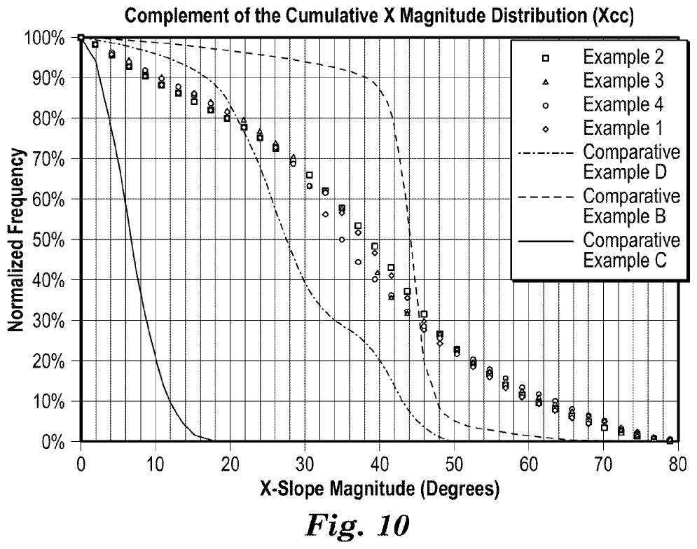

A tool for making the microstructured film of FIG. 4A was prepared according to the description of FIG. 11. Cutter 1040 (FIG. 11), parallel to the z-direction, was used to create an initial thread path t0, having an undulating, pseudo-random motion at a pitch in x-direction of 17.5 micrometers. Cutter 1040 was then retumed to its starting position along roll 1010 and was angularly adjusted by −6 degrees from the z-direction to create an adjacent thread path t1 such that its pitch with relation to t0 was +17.5 micrometers with its undulating, pseudo-random motion synchronized circumferentially around roll 1010 to t0. Cutter 1040 was then returned to its starting position along roll 1010 and was angularly adjusted −6 degrees from the z-direction to create an adjacent thread path t2 such that its pitch with relation to t0 was −17.5 micrometers with its undulating, pseudo-random motion synchronized circumferentially around roll 1010 to t0. The maximum circumferential amplitude variation along a single feature in a thread path (i.e., thread paths t0, t, and t2) on the roll surface was 6 micrometers. The microstructured film of FIG. 4A was prepared using the engraved roll 1010 as the tool according to the process described in ‘Casting Procedure for Preparing Microstructured Films’.

### Example 2

A tool for making the microstructured film of FIG. 4B was prepared according to the description of Example 1 with exception that thread path t0, had an undulating, pseudo-random motion at a pitch in the x-direction of 35 micrometers and two additional thread paths (t3 and t4) were engraved following the creation of thread path t2. After thread path t2 was cut, the cutter 1040 was then returned to its starting position along roll 1010 and was angularly adjusted by +10 degrees from the z-direction to create an adjacent thread path t3 such that its pitch with relation to t1 was +17.5 micrometers with its undulating, pseudo-random motion synchronized circumferentially around roll 1010 to t0. Cutter 1040 was then returned to its starting position along roll 1010 and was angularly adjusted −10 degrees from the z-direction to create an adjacent thread path t4 such that its pitch with relation to t2 was −17.5 micrometers with its undulating, pseudo-random motion synchronized circumferentially around roll 1010 to t0. The maximum circumferential amplitude variation along a single feature in a thread path (i.e., thread paths 10, t1, t2, t3, and t4) on the roll surface was 5 micrometers, The microstructured film of FIG. 4B was prepared using the engraved roll 1010 as the tool according to the process described in ‘Casting Procedure for Preparing Microstructured Films’.

### Example 3

A tool for making the microstructured film of FIG. 5A was prepared according to the description of Example 2 with exception that thread path t0, had an undulating, pseudo-random motion at a pitch in the x-direction of 70 micrometers and two additional thread paths (t5 and t6) were engraved following the creation of thread path t4. After thread path t4 was cut, the cutter 1040 was then returned to its starting position along roll 1010 and was angularly adjusted by −11 degrees from z-direction to create an adjacent thread path t5 such that its pitch with relation to t3 was +17.5 micrometers with its indulating, pseudo-random motion synchronized circumferentially around roll 1010 to t0. Cutter 1040 was then returned to its starting position along roll 1010 and was angularly adjusted −11 degrees from z-direction to create an adjacent thread t6 such that its pitch with relation to t4 was −17.5 micrometers with its undulating, pseudo-random motion synchronized circumferentially around roll 1010 to t0. The maximum circumferential amplitude variation along a single feature in a thread path (ie., thread paths t0, t2, t3, t4, t5, and t6) on the roll surface was 6 micrometers. The microstructured film of FIG. 5A was prepared using the engraved roll 1010 as the tool according to the process described in ‘Casting Procedure for Preparing Microstructured Films’.

### Example 4

A tool for making the microstructured film of FIG. 5B was prepared according to the description of Example 3 with the exception that the maximum circumferential amplitude variation along a single feature in a thread path (i.e., thread paths t0, t1, t2, t3, t4, t5, and t6) on the roll surface was 10 micrometers. The microstructured film of FIG. 5B was prepared using the engraved roll 1010 as the tool according to the process described in ‘Casting Procedure for Preparing Microstructured Films’.

### Example 5

Discs (12.7 mm) of Examples 1-4, Comparative Example A, and the Control Film inoculated with P. aeruginosa were prepared as described in the ‘Sample Disc Inoculation, Incubation and Washing Method’ (described above). The discs were cleaned according to the ‘Sample Disc Cleaning Procedure’ (described above). The cleaned discs were analyzed according to ‘Sample Disc Colony Count Method’(described above). The mean log₁₀ cfu counts are reported in Tables 2 and 3 together with the calculated log₁₀ cfu reduction achieved by cleaning the disc. The results in Table 2 were obtained using a SONTARA 8000 nonwoven sheet soaked in a solution containing TWEEN 20 (0.057) in deionized water as the test wipe. The results in Table 3 were obtained using a WypALL L30 General Purpose Wiper soaked with deionized water that contained PALMOLIVE soap (1 drop per 50 mL of water) as the test wipe.

TABLE 2
Disc Cleaning Using a Wetted SONTARA 8000 Nonwoven Sheet

| | Mean Log₁₀ CFU Recovered | | |
|---|---|---|---|
| | (P. aeruginosa) from a Disc | | Log₁₀ CFU |
| | (n = 3), SD = Standard Deviation | | Reduction |
| Sample Disc | Not Cleaned | Cleaned | from Cleaning |
| Example 1 | 7.79 (SD = 0.23) | 3.71 (SD = 0.40) | 4.08 |
| Example 2 | 7.99 (SD = 0.15) | 4.89 (SD = 0.50) | 3.10 |
| Example 3 | 8.24 (SD = 0.20) | 4.69 (SD = 0.25) | 3.55 |
| Example 4 | 8.16 (SD = 0.09) | 4.84 (SD = 0.70) | 3.32 |
| Control | 8.19 (SD = 0.04) | 6.44 (SD = 0.08) | 1.75 |
| Comparative | 8.01 (SD = 0.18) | 5.06 (SD = 0.25) | 2.95 |
| Example A | | | |

TABLE 3
Disc Cleaning Using a Wetted WypALL
L30 General Purpose Wiper

| | Mean Log₁₀ CFU Recovered | | |
|---|---|---|---|
| | (P. aeruginosa) from a Disc | | Log₁₀ CFU |
| | (n = 3), SD = Standard Deviation | | Reduction |
| Sample Disc | Not Cleaned | from Cleaning | from Cleaning |
| Example 1 | 7.79 (SD = 0.23) | 4.83 (SD = 1.27) | 2.96 |
| Example 2 | 7.99 (SD = 0.15) | 4.89 (SD = 0.58) | 3.10 |
| Example 3 | 8.24 (SD = 0.20) | 4.69 (SD = 0.31) | 3.55 |
| Example 4 | 8.16 (SD = 0.09) | 4.37 (SD = 0.44) | 3.79 |
| Control | 8.19 (SD = 0.04) | 7.13 (SD = 0.56) | 1.06 |
| Comparative | 8.01 (SD = 0.18) | 5.06 (SD = 0.25) | 2.95 |
| Example A | | | |

### Example 6. Reduction of Microbial Touch Transfer

Three different inoculation solutions (A-C) were prepared. Inoculation Solution A (Staphylococcus aureus) was prepared from a streak plate of Staphylococcus aureus (ATCC 6538) on Tryptic Soy Agar (BD236930, Becton, Dickinson and Company, Franklin Lakes, NJ) incubated overnight at 37° C. Two colonies from the plate were used to inoculate 9 mL of sterile Butterfield's Buffer (3M Corporation). The optical density (absorbance) was read at 600 nm to confirm that the reading was 0.040±0.010. If required, the culture was adjusted to be within this range. A portion of the culture (1.5 mL) was added to 45 mL of Butterfield's Buffer in a sterile 50 mL conical tube to make the inoculation solution for the touch transfer experiments.

Inoculation Solution B (Clostridium sporogenes) was prepared from a 1 mL frozen stock of Clostridium sporogenes (ATCC 3584) containing about 1×10⁸ spores/mL that was thawed and diluted to a concentration of about 1×10⁵ spores/mL with Butterfield's Buffer in a sterile, 50 mL conical tube. Inoculation Solution C (Aspergillus brasiliensis) was prepared from a 1 mL frozen stock of Aspergillus brasiliensis (ATCC 16404) containing about 1×10⁶ spores/mL that was thawed and diluted to a concentration of about 1×10⁵ spores/mL with Butterfield's Buffer in a sterile, 50 mL conical tube.

Serial dilution samples of the three inoculation solutions were prepared using Butterfield's Buffer. The dilution samples were plated on 3M PETRIFILM Aerobic Count plates (3M Corporation) and evaluated according to the manufacturer's instructions to confirm the cell concentration used in each experiment.

Samples (40 mm×50 mm) of the microstructured films of Examples 1-4, Comparative Example B, and the Control Film were prepared and individually adhered to the internal, bottom surface of sterile 100 mm Petri dishes using double sided tape. Each Petri dish contained a single sample and each microstructured film sample was attached so that the microstructured surface was exposed. The exposed surface of each microstructured sample and control sample was wiped three times using a KIMWIPE wiper (Kimberly-Clark Corporation, Irving, TX) that had been wetted with a 95% isopropyl alcohol solution. The samples were air dried for 15 minutes in a Biosafety Cabinet with the fan turned on. The samples were then sterilized by for 30 minutes using irradiation from the UV light in the cabinet.

An inoculation solution (25 mL selected from Inoculation Solutions A-C) was poured into a sterile Petri dish (100 mm). For each microstructured sample, an autoclave-sterilized circular disc of Whatman Filter Paper (Grade 2, 42.5 mm diameter; GE Healthcare, Marborough, MA) was grasped using flame-sterilized tweezers and immersed in the Petri dish containing the inoculation solution for 5 seconds. The paper was removed and held over the dish for 25 seconds to allow excess inoculum to drain from the paper. The inoculated paper disc was placed on top of the microstructured sample and a new autoclave-sterilized piece of Whatman Filter paper (Grade 2, 60×60 mm) was placed over the inoculated paper disc. A sterile cell spreader was pressed on the top paper surface of the stack and moved across the surface twice in perpendicular directions. The stack was maintained for two minutes. Both pieces of filter paper were then removed from the microstructured sample using sterile tweezers. The sample was allowed to air dry at room temperature for 5 minutes. Touch transfer of microbial sample from the microstructured surface of each sample was determined by pressing a RODAC plate (Trypticase Soy Agar with Lecithin and Polysorbate 80; from Thermo Fisher Scientific) evenly onto the film sample for 5 seconds using uniform pressure (about 300 g). Individual RODAC plates were incubated aerobically at 37° C. overnight for S. aureus samples; anaerobically at 37° C. overnight for C. sporogenes samples; and aerobically for 48 hours at 30° C. for A. brasiliensis samples. Following the incubation period, the colony forming units (cfu) were counted for each plate. S. aureus and A. brasiliensis samples were tested using three film samples for each with the mean count values reported. C. sporogenes samples were tested using nine film samples with the mean count value reported.

The mean cfu count for each RODAC plate was converted to the log to scale. The log₁₀ reduction in cfu count by touch transfer was determined by subtracting the log₁₀ count value obtained for the microstructured sample from the log to count value obtained for the corresponding control sample (i.e., sample with a smooth surface prepared from the Control Film). The mean % reduction in touch transfer was calculated by Equation A. The results are reported in Tables 4-6.

% Reduction in Touch Transfer=(1−10^{(-log}^{₁₀}^{reduction value)})*100. Equation A:

TABLE 4

| | | Mean log₁₀ | Mean log₁₀ | |
|---|---|---|---|---|
| | | cfu Count | cfu Count | % |
| | | using the | using the | Reduction |
| | Inoculation | Microstruc- | Control | in Touch |
| Sample | Organism | tured Sample | Sample | Transfer |
| Example 1 | S. aureus. | 2.21 | 3.55 | 95 |
| Example 2 | S. aureus | 2.23 | 3.55 | 95 |
| Example 3 | S. aureus | 2.25 | 3.55 | 95 |
| Example 4 | S. aureus | 2.03 | 3.55 | 97 |
| Comparative | S. aureus | 2.36 | 3.55 | 93 |
| Example B | | | | |

TABLE 5

| | | Mean log₁₀ | Mean log₁₀ | |
|---|---|---|---|---|
| | | cfu Count | cfu Count | % |
| | | using the | using the | Reduction |
| | Inoculation | Microstruc- | Control | in Touch |
| Sample | Organism | tured Sample | Sample | Transfer |
| Example 1 | C. sporogenes | 1.58 | 2.35 | 83 |
| Example 2 | C. sporogenes | 2.09 | 2.35 | 45 |
| Example 3 | C. sporogenes | 1.53 | 2.35 | 85 |
| Example 4 | C. sporogenes | 1.65 | 2.35 | 80 |
| Comparative | C. sporogenes | 1.55 | 2.35 | 84 |
| Example B | | | | |

TABLE 6

| | | Mean log₁₀ | Mean log₁₀ | |
|---|---|---|---|---|
| | | cfu Count | cfu Count | % |
| | | using the | using the | Reduction |
| | Inoculation | Microstruc- | Control | in Touch |
| Sample | Organism | tured Sample | Sample | Transfer |
| Example 1 | A. brasiliensis | 1.11 | 1.90 | 84 |
| Example 2 | A. brasiliensis | 1.12 | 1.90 | 83 |
| Example 3 | A. brasiliensis | 0.92 | 1.90 | 90 |
| Example 4 | A. brasiliensis | 0.90 | 1.90 | 90 |
| Comparative | A. brasiliensis | 1.41 | 1.90 | 68 |
| Example B | | | | |

### Example 7. Scratch Visualization Testing of Microstructured Films

Samples of the microstructured films of Examples 1-4 and Comparative Example B were individually tested using a TABER Model 5750 Linear Abraser (Taber Industries, North Tonawanda, NY). A 2.54 cm by 2.54 cm section of a SCOTCH-BRITE Power Pad 2000 (3M Corporation, St. Paul, MN) was adhesively attached to the bottom of the instrument testing arm and used as the abrasive material in the test. Each microstructured sample (3.8 cm by 12.7 cm) was adhesively attached to a horizontally positioned glass surface with the microstructured surface exposed for contact with the abrasive pad. In operation, the abrasive pad was placed in contact with the microstructured surface and operated in a linear back and forth motion across the microstructured surface for 50 cycles (frequency of 60 cycles/minute) with a load of 75 g attached to the upper end of the testing arm. At the completion of each test, the microstructured film sample was placed flat on a black horizontal surface. The microstructured surface was visually examined for scratches at an angle approximately perpendicular to the horizontal surface using ambient room lighting. For the microstructured film samples of Examples 1-4, no scratches were observed on any of the microstructured surfaces. For the microstructured film of Comparative Example B, many scratches were observed on the microstructured surface.

### Example 8. Scratch Visualization Testing of Microstructured Films

The same procedure as described in Example 7 was followed with the exception that the abrasive pad was placed in contact with the microstructured surface and operated in a linear back and forth motion across the microstructured surface for 100 cycles (frequency of 60 cycles/minute) with a load of 75 g attached to the upper end of the testing arm. For the microstructured film samples of Examples 1-4, no scratches were observed on any of the microstructured surfaces. For the microstructured film of Comparative Example B, many deep scratches were observed on the microstructured surface.

### Example 9. Scratch Visualization Testing of Microstructured Films

The same procedure as described in Example 7 was followed with the exception that the abrasive pad was placed in contact with the microstructured surface and operated in a linear back and forth motion across the microstructured surface for 50 cycles (frequency of 60 cycles/minute) with a load of 325 g attached to the upper end of the testing arm. For the microstructured film samples of Examples 1-4, a few superficial scratches were observed on each of the microstructured surfaces. For the microstructured film of Comparative Example B, many deep scratches were observed on the microstructured surface.

### Example 10. Transmission, Clarity and Gloss Measurements

Transmission and clarity were measured for the microstructured films of Examples 1-4 and Comparative Example B using a BYK Haze-Gard plus meter (BYK-Gardner USA, Columbia, MD) with the ASTM D1003 standard method setting. Film samples were individually placed in the instrument holder with each film oriented so that the microstructured surface faced the light source. The results are presented in Table 7.

Gloss measurements of the microstructured films of Examples 1-4 and Comparative Example B were obtained using a BYK Micro-Tri-Gloss meter (BYK-Gardner). For the measurements, the films were placed on a black glass plate with each film oriented so that the microstructured surface faced the gloss meter. The results are presented in Table 8.

TABLE 7

| Microstructured | Transmission | Clarity |
|---|---|---|
| Film | (%) | (%) |
| Example 1 | 97.6 | 1.3 |
| Example 2 | 97.4 | 0 |
| Example 3 | 96.5 | 0 |
| Example 4 | 96.9 | 1.4 |
| Comparative | 100.0 | 41.9 |
| Example B | | |

TABLE 8

| | |
|---|---|
| Microstructured | Gloss Measurements (GU) |

| Film | 20 degrees | 85 degrees |
|---|---|---|
| Example 1 | 2.5 | 2.6 |
| Example 2 | 4.5 | 8.1 |
| Example 3 | 3.0 | 3.4 |
| Example 4 | 1.6 | 1.9 |
| Comparative | 77.9 | 98.3 |
| Example B | | |

### Example 11. Luminance Profiles

Microstructured films of Examples 1-4 and Comparative Example B were individually placed on a Lambertian light source. An Eldim L80 conoscope (Eldim SA, Herouville-Saint-Clair, France) was used to detect light output in a hemispheric fashion at all polar and azimuthal angles simultaneously. Each film was oriented so that the microstructured surface faced the conoscope. After detection, a cross section of transmission (e.g., brightness) readings was taken in a direction orthogonal to the direction of the louvers (denoted as a 0° orientation angle), unless indicated otherwise. Relative transmission (i.e., brightness of visible light) was defined as the percentage of on-axis luminance, at a certain viewing angle, between a reading with film and a reading without the film.

The light box was a six-sided hollow cube measuring approximately 12.5 cm×12.5 cm×11.5 cm (L×W×H) made from diffuse polytetrafluoroethylene (PTFE) plates of about 6 mm thickness. One face of the box was chosen as the sample surface. The hollow light box had a diffuse reflectance of about 0.83 measured at the sample surface (i.e., about 83% averaged over the 400-700 nm wavelength range). During testing, the box was illuminated from within through a 1 cm circular hole in the bottom of the box (opposite the sample surface, with the light directed toward the sample surface from inside). The illumination was provided using a stabilized broadband incandescent light source attached to a fiber-optic bundle to direct the light (Fostec DCR-II with a 1 cm diameter fiber bundle extension, from Schott-Fostec LLC, Auburn, NY). Plots of the measured 90° and 0° luminance cross section data are reported in FIGS. 13A and 13B.

### Example 12

Sheets of an architectural finish film (3M DI-NOC Architectural Finish ST-1586, obtained from the 3M Corporation) were individually embossed using a single tool selected from Examples 1-4. 3M DI-NOC Finish ST-1586 was obtained as a laminate (8 mil thick) film having a polyvinyl chloride (PVC) film top layer, a vinyl based film with decorative printing as the middle layer, and a pressure sensitive adhesive backing. The pressure sensitive adhesive backing was covered with a release liner. A metal roll was heated to 118° C. and partially wrapped with the film in order to soften the film. A microstructured tool roll was nipped to the heated roll at 4000 lbs pressure. The rolls were rotated slowly at 0.3 meters per minute resulting in embossing of the microstructured features (i.e. a negative replication) into the top layer of the film.

### Example 13

A microstructured film was prepared according to the procedure described in Example 4 with the exception that the PET support film was replaced with a polyvinyl chloride (PVC) support film. The PVC support film was 3M SCOTCHCAL Gloss Overlaminate 8518 film (2 mil) which contained a pressure sensitive adhesive on one side (obtained from the 3M Corporation). The total thickness of the resulting microstructured film was 3 mils.

A sample of the 3M SCOTCHCAL Gloss Overlaminate 8518 film was used as an example of a conformable film and was designated as Comparative Example E for testing. A sample of 3M Durable Protective Film 7760AM (2 mil PET Film with a pressure sensitive adhesive on one side, obtained from the 3M Corporation) was used as an example of a non-conformable film and was designated as Comparative Example F for testing. The release liners were removed from the adhesive sides of all samples before testing.

Tensile and elongation testing of the films was conducted according to ASTM D3759-05 “Standard Test Method for Breaking Strength and Elongation of Pressure-Sensitive Tape”. The film samples (1 inch (2.54 cm) wide) were tested at 23° C. using an Instron Universal Test Machine (Illinois Tool Works, Glenview, IL) that was operated with an initial grip distance of 2 inches (5.08 cm) and speed of 12 inches per minute (30.5 cm per minute). The measurements of Percent Elongation, Tensile Strength (MPa), and Load at 0.25 inches (6.35 mm) Fixed Extension (N) are reported for each sample in Table 7.

TABLE 9

| | | | Load at 0.25 |
|---|---|---|---|
| | Percent | Tensile Strength | inches Fixed |
| | Elongation | (MPa) | Extension (N) |
| Microstructured Film of | 58% | 35 MPa | 34N |
| Example 13 | | | |
| Comparative | 280% | 32 MPa | 24N |
| (Non-Microstructured | | | |
| PVC Film) | | | |
| Comparative | 123% | 184 MPa | 159N |
| (Non-microstructured | | | |
| PET Film) | | | |

### Example 14

A microstructured film was prepared according to the procedure described in Example 4 with the exception that the PET support film was replaced with a polyurethane (PUR) support film. The PUR support film was 3M ENVISION Gloss Wrap Overlaminate 8548 film (2 mil) which contained a pressure sensitive adhesive on one side (obtained from the 3M Corporation). The total thickness of the resulting microstructured film was 3 mils. A sample of the 3M ENVISION Gloss Wrap Overlaminate 8548 film was used as an example of a conformable film and was designated as Comparative Example H for testing.

Tensile and elongation testing of the films was conducted as described in Example 13. The measurements of Percent Elongation, Tensile Strength (MPa), and Load at 0.25 inches (6.35 mm) Fixed Extension (N) are reported for each sample in Table 8.

TABLE 10

| | | | Load at 0.25 |
|---|---|---|---|
| | Percent | Tensile Strength | inches Fixed |
| | Elongation | (MPa) | Extension (N) |
| Microstructured Film of | 67% | 34 MPa | 26N |
| Example 14 | | | |
| Comparative | 130% | 62 MPa | 30N |
| (Non-Microstructured | | | |
| PUR Film) | | | |

1. A structured surface comprising a plurality of structures having a complement cumulative slope magnitude distribution (Fcc) such that
at least 30, 40, 50, 60, 70, 80 or 90% of the structures have a slope greater than 10 degrees; and
less than 80% of the structures have a slope greater than 35 degrees.

2. The structured surface of claim 1 wherein the structures comprise peaks and valleys defined by a Cartesian coordinate system such that the peaks and valleys have a width and length in the x-y plane and a height in the z-direction and at least a portion of the peaks and/or valleys vary in height in the y direction by at least 10% of the average height.

3. The structured surface of claim 1 wherein the structures comprise peaks and valleys defined by a Cartesian coordinate system such that the peaks valleys have a width and length in the x-y plane and a height in the z-direction and at least a portion of the peaks and/or valleys vary in height in the x direction by at least 10% of the average height.

4. The structured surface of claim 1 wherein the structures comprise two or more facets.

5. The structured surface of claim 4 wherein the facets form continuous or semi-continuous surfaces in the same direction.

6. The structured surface of claim 1 wherein structures comprise peaks having an apex that is sharp, rounded or truncated.

7. The structured surface of claim 1 wherein the structured surface comprises an array of modified prisms wherein the apexes thereof are rounded.

8. The structured surface of claim 1 wherein the structured surface comprises less than 50, 40, 30, 20 or 10% of flat surface area that is parallel to the planar base layer.

9. The structured surface of claim 1 wherein the structured surface comprises valleys lack intersecting walls.

10. The structured surface of claim 1 wherein the structured surface comprises valleys having an average width ranging from 1 micron to 10 mm, or 1 micron to 1 mm, or 1 micron to 500 microns.

11. The structured surface of claim 1 wherein the structured surface has a Sbi/Svi of greater than 3 and less than 90.

12. The structured surface of claim 1 wherein the structured surface is disposed on a planar base layer and the structured surface and planar base layer comprise an organic polymeric material.

13. The structured surface of claim 1 wherein the structured surface alone or in combination with the planar base layer is transparent, light-transmissive, or opaque.

14. The structured surface of claim 1 wherein the structured surface alone or in combination with the planar base layer has one or more properties selected from:
less visually apparent scratches than a linear prism film;
a transmission of at least 90 or 95%;
a clarity of less than 10, 5, or 1;
a gloss at 20 degrees of less than 10 or 5;
a gloss at 85 degrees of less than 10 or 5;
a luminance at 0 degrees of greater than 10, 11, or 12 cd/m² for a viewing angles ranging from −40 to +40 degrees;
a luminance at 90 degrees of greater than 10, 11, or 12 cd/m² for a viewing angles ranging from −40 to +40 degrees; and
a luminance at 0 and/or 90 degrees that varies by less than 5, 4, 3, 2, or 1 cd/m² for viewing angles ranging from −40 to +40 degrees.

15. A structured surface comprising a plurality of structures having a complement cumulative slope magnitude distribution (Fcc) such that
at least 30, 40, 50, 60, 70, 80 or 90% of the structures have a slope greater than 10 degrees; and one or more of the following criteria
i) at least 10, 20, or 30% of structures have a slope greater than 50 degrees;
ii) at least 10 or 20% of structures have a slope greater than 60 degrees;
iii) less than 70, 60, or 50% of structures have a slope greater than 40 degrees;
iv) less than 90 or 80% of structures have a slope greater than 30 degrees; and
v) less than 90% of structures have a slope greater than 20 degrees.

16. A structured surface comprising a plurality of structures having a complement cumulative slope magnitude distribution (Xcc) such that
at least 45, 50, or 60% of the structures have a slope greater than 30 or 35 degrees; and
less than 85 or 80% of the structures have a slope greater than 40 degrees or having a (Ycc) such that
at least 20, 25, 30, 35, 40, 45, or 50% of the structures have a slope greater than 10 degrees; and
less than 55, 50, 45, 40, 35, 30, 25 or 20% of the structures have a slope greater than 30 degrees.

17-20. (canceled)

21. An article comprising the structured surface of claim 1.

22. The article of claim 21 wherein the article is a film or tape further comprising an adhesive on the opposing surface of the planar base layer.

23. (canceled)

24. The article of claim 21 wherein the film or tape is a graphic article, packaging article, protective article, or a combination thereof.

25-35. (canceled)
